(19) United States
(12) Patent Application Publication
(10) Pub. No.: US 2026/0061772 A1
(43) Pub. Date: Mar. 5, 2026

(54) AIR LINE FITTINGS FOR AERODYNAMIC WHEEL COVERS AND MOUNTING ASSEMBLIES

(71) Applicant: FlowBelow Aero, Inc., Round Rock, TX (US)

(72) Inventors: Nicholas Love, Round Rock, TX (US); Joshua Butler, Austin, TX (US); Miguel Mendoza Sandoval, Austin, TX (US); Roberto Urista, Austin, TX (US)

(21) Appl. No.: 19/315,293

(22) Filed: Aug. 29, 2025

Related U.S. Application Data
(60) Provisional application No. 63/688,351, filed on Aug. 29, 2024.

(51) Int. Cl. B60B 7/00

(52) U.S. Cl. CPC B60B 7/0026

(57) ABSTRACT

Embodiments include an aerodynamic wheel cover system having an air delivery system to connect vehicle tires to accessible locations that are accessible when a wheel cover is mounted. An embodiment includes a mounting bracket for mounting to a hub of a vehicle, a base assembly mounted to the mounting bracket, a wheel cover adapted to mount to the base assembly, and a plurality of air fittings. Each of the plurality of air fittings may extend from an inboard side of the wheel cover and through the wheel cover to a respective accessible location that is accessible when the wheel cover is mounted to the base assembly. Each of the air fittings may include an accessible portion accessible at the respective accessible location.

### RELATED APPLICATIONS

This application claims the benefit of priority under 35 U.S.C. § 119 (e) to U.S. Provisional Application No. 63/688,351, entitled “Air Line Fittings for Aerodynamic Wheel Covers and Mounting Assemblies,” filed Aug. 29, 2024, which is hereby fully incorporated by reference herein.

### TECHNICAL FIELD

This disclosure relates to systems and methods for aerodynamic wheel covers for vehicle wheels More specifically, this disclosure relates to systems and methods for air line fittings for aerodynamic wheel covers.

### BACKGROUND

Tractor-trailers travel significant distances every year. Consequently, the cumulative effect of even incremental amounts of drag on a tractor-trailer can lead to significant increases in overall operating costs. Such increased transportation costs are typically absorbed by consumers of the products transported. One significant source of drag on tractor-trailers, and hence increased transportation costs, are the wheel assemblies of the tractor-trailers. In general, the aerodynamic drag of a vehicle increases when air flow is affected by a wheel opening, especially deep wheel openings commonly found on tractor-trailer vehicles. Consequently, aerodynamic wheel covers are becoming increasingly popular for reducing drag. However, in many cases wheel covers may complicate access to important components of a wheel such as valves for checking or maintaining air pressure of a vehicle tire.

Ensuring optimal tire pressure in tractor-trailer tires is essential for safety, tire longevity and fuel efficiency. In dual-wheel configurations, accessing the valve stem of the inner tire, and sometimes even the outer tire, can be challenging due to spatial constraints. To address this issue, vehicles are often outfitted with valve stem extenders. However, the increasing adoption of aerodynamic wheel covers has introduced additional barriers to accessibility, often necessitating the removal of these covers to reach the extenders. As a result, routine tire pressure checks and adjustments are sometimes not completed by drivers, potentially compromising vehicle performance, maintenance and safety.

As such, it is desired to improve and simplify access to such components in association with the use of wheel covers.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 illustrates one embodiment of a wheel with an aerodynamic wheel cover system mounted thereon.

FIG. 2A is a cross-sectional view of one embodiment of a dual wheel assembly to which one embodiment of an aerodynamic wheel cover system is mounted.

FIG. 2B illustrates a cross-sectional view of a portion of one embodiment of a wheel cover system in more detail.

FIG. 3 illustrates one embodiment of components for air delivery.

FIG. 4A illustrates an exploded view of one embodiment of an air fitting.

FIG. 4B illustrates a cross-sectional view of one embodiment of an air fitting portion.

FIG. 5 illustrates one embodiment of a valve opening pin.

FIG. 6 illustrates one embodiment of an outboard end of an air line.

FIG. 7 illustrates one embodiment of a mounting assembly.

FIG. 8 illustrates one embodiment of a mounting bracket.

FIG. 9 is an exploded view illustrating portions of one embodiment of the wheel cover system.

FIG. 10 illustrates one embodiment of a push-and-turn base assembly piston.

FIG. 11 illustrates one embodiment of a push-and-turn base assembly base.

FIG. 12 illustrates one embodiment of a push-and-turn base assembly alignment member.

FIG. 13A illustrates a first view of another embodiment of a mounting bracket.

FIG. 13B illustrates an outboard view of the mounting bracket of FIG. 13A.

FIG. 14 illustrates another embodiment of an air fitting.

FIG. 15 illustrates a cross-sectional view of one embodiment of a first fitting portion.

FIG. 16 illustrates a view from the inboard side of one embodiment.

FIG. 17 illustrates a view from an outboard side of one embodiment of a mounting bracket.

FIG. 18 illustrates the inboard side of one embodiment of a base.

FIG. 19 illustrates an embodiment of an aerodynamic wheel cover system that includes keyhole slots and circlips.

FIG. 20 illustrates one embodiment of a junction.

FIG. 21A is a cross-sectional view of one embodiment of a junction.

FIG. 21B is a cross-sectional view of another embodiment of a junction.

FIG. 22 illustrates one embodiment of mounting a junction to a bracket.

FIG. 23A illustrates a first view of one embodiment of an air fitting.

FIG. 23B illustrates a second view of the embodiment of FIG. 23A.

FIG. 23C illustrates a cross-section of the embodiment of FIG. 23A.

FIG. 23D illustrates one embodiment of components of an air fitting.

FIG. 23E illustrates one embodiment of air fittings, a mounting bracket and a base.

FIG. 24A illustrates another embodiment of a system for fittings for air lines connecting tires to an accessible location through wheel cover assembly.

FIG. 24B illustrates an inboard view of one embodiment of an aerodynamic wheel cover system incorporating the system of FIG. 24A.

FIG. 25 illustrates one embodiment of a tire monitoring system.

FIG. 26A illustrates one embodiment of a wheel cover assembly with visible indicators to communicate information to a user.

FIG. 26B illustrates another embodiment of a wheel cover assembly with visible indicators.

FIG. 26C illustrates an outboard view of one embodiment of the wheel cover assembly with visible indicators.

FIG. 27 illustrates an outboard view of a wheel cover assembly with a display.

FIG. 28 illustrates one embodiment of information displayed on a display.

FIG. 29 illustrates another embodiment of a user interface for a wheel cover assembly.

FIG. 30 illustrates another embodiment of a system for fittings for air lines connecting tires to an accessible location through wheel cover assembly.

FIG. 31 illustrates an elevated assembled view of the embodiment of FIG. 30.

FIG. 32A illustrates one embodiment of air lines with integrated fittings and a retainer for mounting them.

FIG. 32B illustrates one embodiment of an inboard view of an aerodynamic wheel cover assembly incorporating the air lines and retainers of FIG. 32A.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

To illustrate in more detail, certain types of systems for aerodynamic wheel covers and systems and methods for attaching those aerodynamic wheel covers to a dual wheel or single-wide wheel assembly on a vehicle have been developed. In particular, embodiments disclosed herein may include an aerodynamic wheel cover assembly, comprising a mounting assembly configured to couple to a wheel, a base assembly for coupling with the mounting assembly and a disk (or wheel cover) assembly for coupling to the base assembly. The base assembly can include a variety of components including buttons, pistons, bushings, springs, etc. The disk assembly may include, or be coupled to, an inner ring having a plurality of tabs and a disk (wheel cover) such that by a translation of the inner ring or the disk or disk assembly relative to the base assembly (e.g., by less than a full revolution or turn) the disk can be coupled, or secured, to the wheel. Embodiments of the present disclosure may be used with a wide variety of wheel covers and mounting methods.

Embodiments of such aerodynamic wheel cover systems (also referred to as wheel cover assemblies) may provide wheel cover mounting arrangements that include an air hose extension and a valve positioned on a disk of such wheel cover systems, disk components (base) of the wheel cover system, or in an opening adjacent the disk of to provide means for inspecting or maintaining tire pressure.

Embodiments of the present disclosure provide improved systems and methods for including air fittings in aerodynamic wheel cover systems. Generally, then, embodiments as disclosed here may provide an aerodynamic wheel cover system that includes one or more air fittings. The air fittings may, for example, be integrated with, affixed, or otherwise secured to, a bracket assembly or other component of the wheel cover system. Each air fitting may be coupled to a valve on the wheel with which the aerodynamic wheel cover system is being utilized. For example, the air fitting may be adapted to be coupled (e.g., via an air line) to a valve on an inner wheel of a dual wheel and a valve on an outer wheel of a dual wheel. The air fitting may also have a portion that is accessible when the wheel cover is mounted on the wheel. For example, the accessible portion of the air fitting may be routed through the base assembly and wheel cover of the wheel cover system or through the cover of the wheel cover system without being routed through the base assembly. The accessible portion of the wheel cover system may be adapted to accept an air tool or the like such that the air pressure of a tire of the wheel with which the wheel cover assembly is being utilized may be checked or altered through the accessible portion of the air fitting.

An air fitting may be a single-piece or fitting or may comprise several portions that may be assembled together to create the air fitting. Air fitting portions, which may themselves be air fittings, may be secured to one another (e.g., bolt together). An air fitting may be adapted for coupling to an air line to one side and may have internal threads to allow a valve core, such as a Schrader valve core, to be coupled to the air fitting. An air fitting may have external threads to allow a cap or another air fitting, such as, but not limited to, a flow through valve to be mounted. In some embodiments, for example, an air fitting includes a flow through valve cap, such as a double sealed flow through valve cap. The additional air fitting may be compatible with the valve of the air fitting to which it mounts.

In some embodiments, an air fitting is utilized in association with a keyhole (e.g., a hole shaped to secure the air fitting) to lock onto a mounting bracket of the wheel cover assembly. Air fittings may have keys that fit through key slots in the mounting assembly. With the keys having passed through the key slots, the air fittings may be rotated so that the keys no longer align with the key slots thereby helping to retain the air fittings. In some embodiments, the air fittings are secured to one another (e.g., bolt together). An air fitting may be mechanically secured in place with respect to the mounting assembly using an alternative or additional securing mechanism such as a circlip or the like.

In some embodiments, multiple air fittings may be integrated into a single part. Each air fitting may have a separate fluid path or a shared fluid path. The single integrated air fitting apparatus may include one or more integrated mounting holes or an integrated bracket or boss or another feature for coupling to a mounting bracket of the wheel cover assembly.

In some embodiments, a portion of the base assembly may include a corresponding shape (e.g., a feature) to secure the air fitting in place. As another embodiment the air fitting may be mechanically secured in place with respect to the bracket assembly using an alternative or additional securing mechanism such as a circlip or the like.

In some embodiments, the aerodynamic wheel cover system including such an air fitting may be adapted to secure these air lines in some manner to ensure that such air lines are not abraded, do not become tangled, have a desired tension, or to ensure that the air lines are not otherwise subjected to unwanted stresses. Such embodiments, may, for example, constrain the air lines within the base assembly, bracket, etc. of the wheel cover assembly to eliminate possible movement, loosening or disengagement of the air lines, especially in light of the extreme environmental conditions (e.g., vibration, dirt, etc.) to which these wheel cover assemblies may be subject.

Some embodiments may include one or more of the following features: an angled fitting (e.g., 90 degree fitting, 45 degree fitting, or otherwise angled fitting) or straight fitting with bolt attachment on its sides to accommodate mounting hardware for mounting to a mounting bracket; an angled or straight fitting adapted to route through a mounting bracket; an angled or straight fitting adapted to route through a base assembly; an angled or straight fitting adapted to route through a wheel cover; air fittings with interlocking parts to prevent rotation; air fittings that bolt or otherwise coupled together in center; air fittings that bolt or otherwise couple together off center; air fittings that fit into a mounting bracket through a keyhole slot; air fittings that fit into a mounting bracket thru a keyhole slot and bolt together to secure them; air fittings that grab bolts on the mounting brackets or share bolts; an angled fitting (e.g., a 90-degree fitting, a 45-degree fitting, or otherwise angled fitting) bolted to a side of a base assembly which may shorten an air line (e.g., hose, valve extender) coupling the air fitting to a wheel valve; air fittings that clamp or otherwise are attached to a mounting bracket next to a base assembly; a clip for a bolt system (e.g., a 3 bolt system) that allow multiple angled fittings to attach-either folded down on sides or that fits over a feature on the angled fittings; a fold down portion of a bracket to allow 90 degree fittings to attach; hose clamps to retain air fittings; a clip to hold an air hose and prevent rotation of the hose or fitting; an input device to receive user input based on interaction with the input device; a Tire Pressure Monitoring System (TPMS) mounted on the air fittings: a display on the wheel cover that displays, or transmits data such as tire pressure, temperature, if one or more lug nuts are loose, treadwear, if a tire is out of balance, video or images from cameras that monitor components of the wheel cover system or wheel assembly or other data; a camera that is positioned to monitor various components of the wheel assembly and transmit images or video (e.g., for inspections performed by an operator remotely or automatically by artificial intelligence or other means); a visible indicator such as a blinking light that indicates if tire pressure, temperature, or other data is within normal operating range or out of normal operating range; an auditory signal such as a speaker that produces a desired sound to alert an operator of an issue such as data from a sensor outside of normal operating range; a solar cell (e.g., on center cap) to maintain power; air fittings on the side of the base assembly; a junction per air line with mount on side of the base assembly; a clip (e.g., U-Clip) to attach to legs of mounting or other bracket to hold air lines; an angle fitting (e.g., a 90-degree fitting, a 45-degree fitting, etc.) with C-Clip; an angle fitting (e.g., a 90 degree fitting, a 45 degree fitting) with a screw on mount; a push-in spring auto lock with a fitting; a keyed fitting (e.g., push in and rotate) held by the base assembly; an angled single piece fitting with a bolt hole; an angled single piece fitting with a junction; a press fit air fitting press fit into the mounting bracket; a press fit air fitting adapter with threads inside; an offset mounting bracket with holes in the wheel cover; a one-way spring push lock.

Accordingly, embodiments may provide an aerodynamic wheel cover system including an air fitting, that allows air lines to be accessible without removing a wheel cover (e.g., when the wheel cover is coupled to the wheel). Moreover, embodiments may allow air lines to be fitted without altering the functionality or efficacy of the latch or coupling mechanism of a wheel cover system. It will be noted here that these embodiments are described by way of example, those of ordinary skill in the art with the benefit of this disclosure will understand various variations and other embodiments and implementations of such aerodynamic wheel cover systems. All such embodiments and variations are contemplated herein.

While discussed primarily in terms of mounting wheel covers to the wheels of the tractor of a tractor-trailer, embodiments may be adapted for use with the trailer wheels of a tractor-trailer or with other types of vehicle wheels. Moreover, while the embodiments depicted typically use a pair of straight fittings or angled fittings having the same angle, the fittings may have other configurations. For example, one fitting may be a straight fitting and the other fitting may be angled (e.g., one fitting may be a 45-degree fitting, a 90-degree fitting, or other angled fitting). In another embodiment, two angled fittings are used with the angled fittings having different angles (e.g., a 90-degree fitting and a 45-degree fitting). Further, while 45-degree and 90-degree fittings are provided as examples, the fittings may have any desired angle. Moreover, different types of fittings may be used to connect to the inboard tire and the outboard tire. By way of example, one fitting may have one design and the other fitting a different design such that different types of fittings may be used together (e.g., a fitting 150 may be used for one air line and an air line 800a, 800b, 1300a, 1330b with an integrated fitting for the other air line). Thus, various embodiments may be used together.

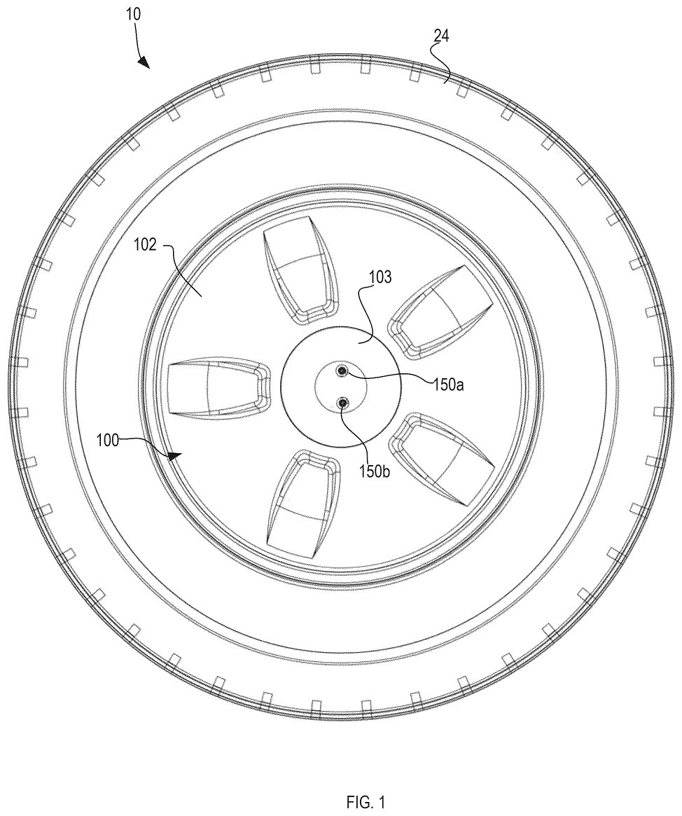

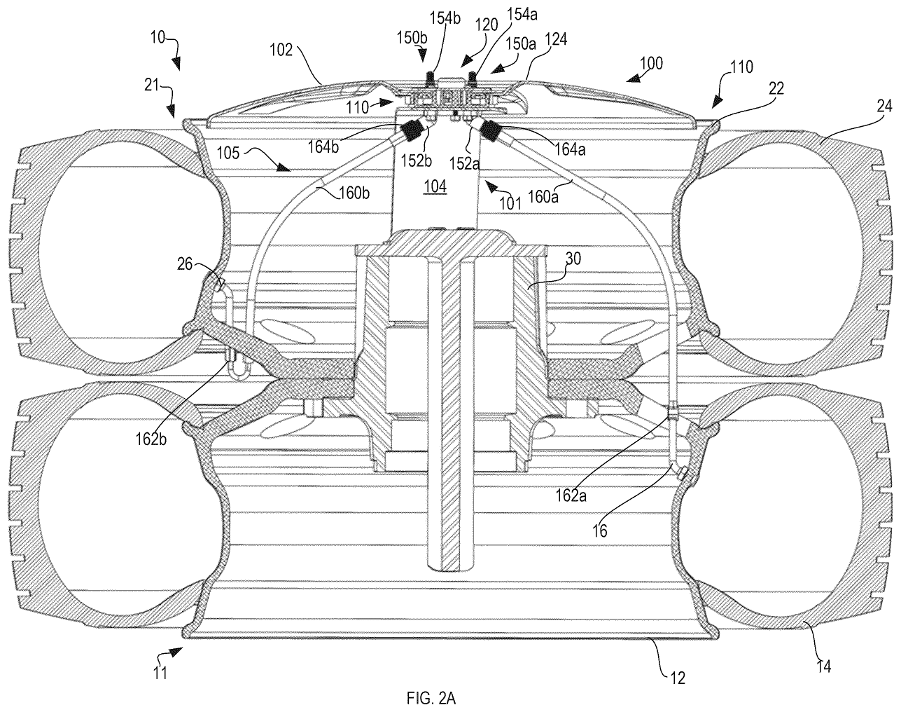

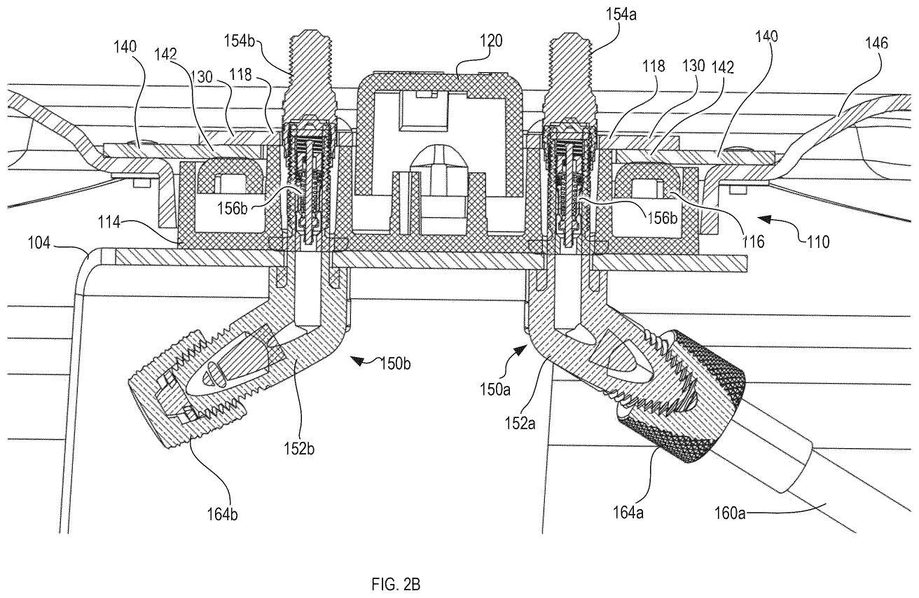

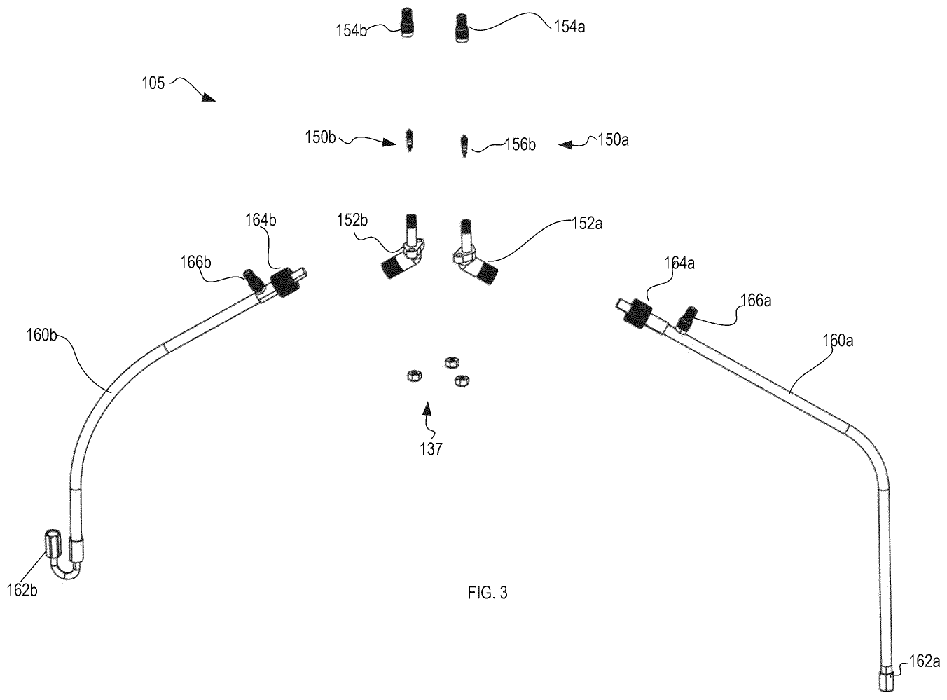

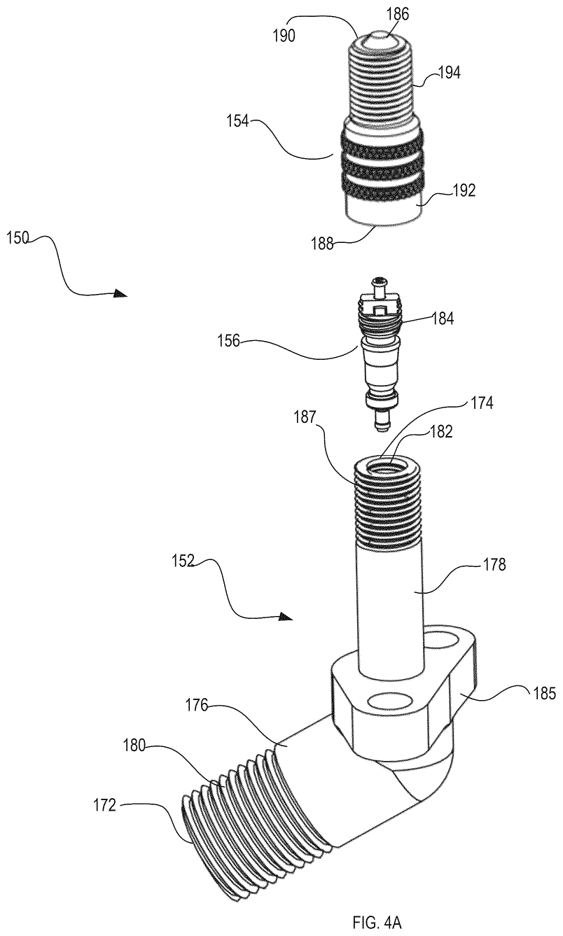

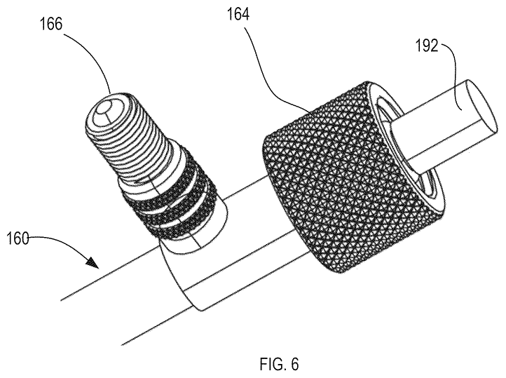

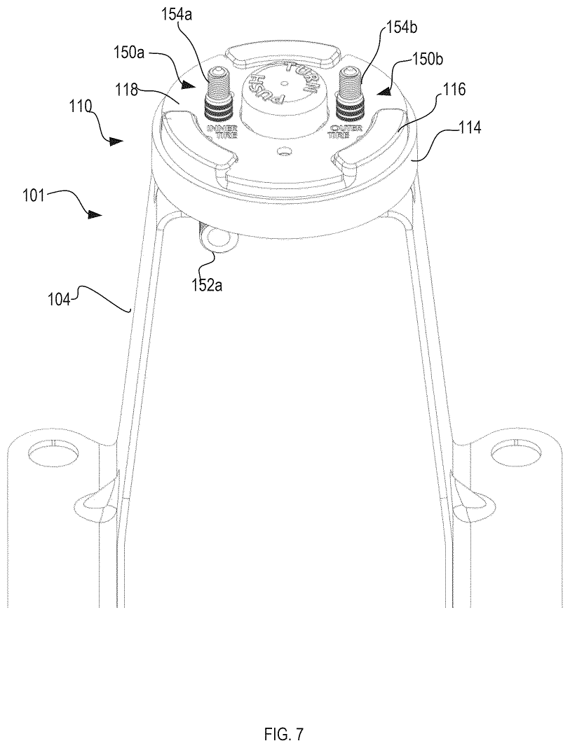

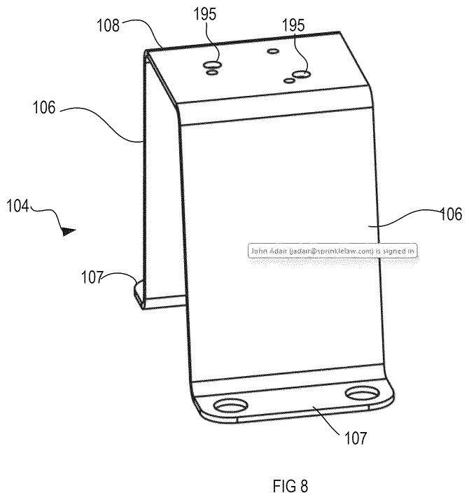

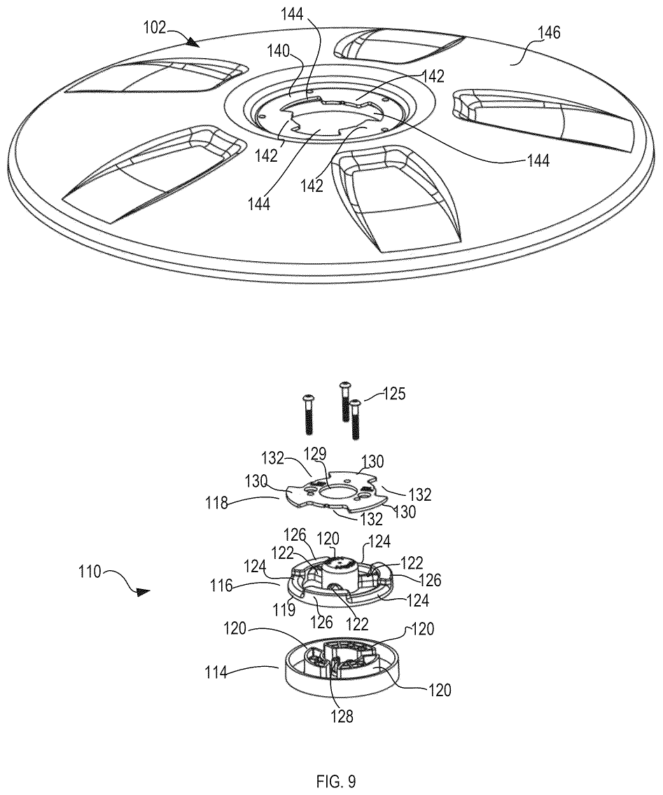

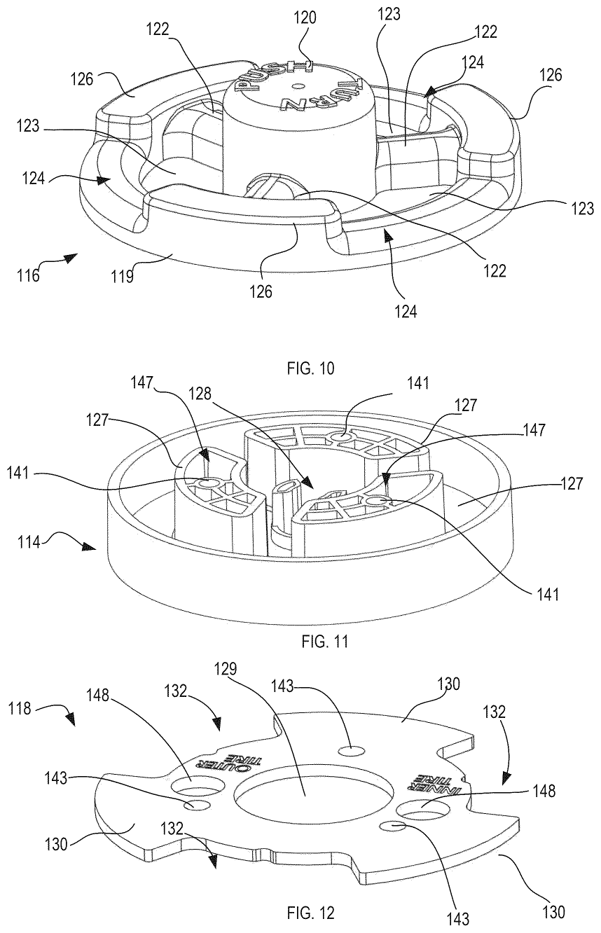

FIG. 1 illustrates one embodiment of dual wheel assembly 10 with an aerodynamic wheel cover system 100 mounted. FIG. 2A is a cross-sectional view of one embodiment of a dual wheel assembly 10 with wheel cover system 100 mounted. FIG. 2B illustrates a cross-sectional view of a portion of one embodiment of wheel cover system 100 in more detail. FIG. 3 illustrates one embodiment of an air delivery system 105. FIG. 4A illustrates an exploded view of one embodiment of an air fitting 150 and FIG. 4B illustrates a cross-sectional view of one embodiment of an air fitting portion 152. FIG. 6 illustrates one embodiment of an outboard end of an air line 160. FIG. 7 illustrates one embodiment of a mounting assembly 101. FIG. 8 illustrates one embodiment of a mounting bracket 104 of mounting assembly 101. FIG. 9 is an exploded view illustrating portions of one embodiment of wheel cover system 100, in particular one embodiment of a wheel cover 102 and one embodiment of a push-and-turn base assembly 110. FIG. 10 illustrates one embodiment of a push-and-turn base assembly piston 116. FIG. 11 illustrates one embodiment of a base 114 of a push-and-turn base assembly 110. FIG. 12 illustrates one embodiment of an alignment member 118 of a push-and-turn base assembly 110.

Dual wheel assembly 10 includes an inner wheel 11 and an outer wheel 21. Inner wheel 11 comprises an inner wheel rim 12 to which an inner tire 14 is mounted. Outer wheel 21 comprises an outer wheel rim 22 to which an outer tire 24 is mounted. Inner wheel 11 and outer wheel 21 are mounted to a wheel hub 30 of a vehicle. As will be appreciated, hub 30 is coupled to a drive or non-drive axle. An inner wheel air tube 16 is provided for inflating/deflating or checking the pressure of tire 14 and an outer wheel air tube 26 is provided for inflating/deflating or checking the pressure of tire 24. Air tubes 16 may be valve stems that house valve cores. Typically, valve stems used in vehicles include internal Schrader valves.

Aerodynamic wheel cover system 100 includes a mounting assembly 101 for mounting a wheel cover 102 to hub 30. In the embodiment illustrated, mounting assembly 101 comprises a mounting bracket 104 that mounts to hub 30 and a push-and-turn base assembly 110 that mounts to mounting bracket 104. Wheel cover 102 can be removably attached to base assembly 110, and hence the vehicle, using a push-and-turn motion.

When the wheel cover 102 is installed, direct access to air tubes 16 and 26 is obstructed. Even in the absence of wheel cover 102, the substantial dimensions of the dual wheel assembly 10 may render these components difficult to reach. To facilitate tire pressure monitoring and air management (inflation or deflation) while the wheel cover 102 remains in place, aerodynamic wheel cover system 100 incorporates an air delivery system 105 that connects tractor tires 14, 24 to an accessible location. This system 105 establishes a remote access point for the tractor tires 14 and 24. In the depicted embodiment, the air delivery system 105 comprises air lines 160a and 160b, which extend from the tire air tubes 16 and 26 to externally accessible air fittings 150a and 150b. These fittings remain reachable even with the wheel cover mounted and may be configured to interface with air tool chucks. Although illustrated as a 45-degree fittings, the angular configuration of fittings 150a, 150b may vary to accommodate different installation requirements. By way of example, but not limitation, straight fittings or 90-degree fittings or otherwise angled fittings may be used in some implementations.

Each air fitting 150a and 150b is operatively connected to a corresponding air tube associated with the wheel to which the aerodynamic wheel cover system 100 is applied. Specifically, air fitting 150a is fluidly coupled to air tube 16 of the inner wheel of the dual wheel assembly 10 via air line 160a, while air fitting 150b is similarly connected to valve stem 26 of the outer wheel via air line 160b. The air lines 160a and 160b are each equipped with inboard fittings 162a, 162b and outboard fittings 164a, 164b. The inboard fittings 164a and 164b are configured to interface with the respective air tubes 16 and 26, whereas the outboard fittings 162a and 162b are designed to connect to the corresponding air fittings 150a and 150b, thereby enabling a continuous and accessible pneumatic pathway.

As discussed, in some embodiments air tubes 16, 26 are valve stems that include internal valve cores, such as Schrader valve cores. In such an embodiment, an air line 160a, 160b may be a valve stem extender that includes a mechanism to open the valve in air tube 16, 26. For example, as is known in the art, a valve stem extender may have an internal rod or pin to push on the valve core in an existing valve stem, thereby opening the existing valve when the extender is fully attached. Thus, it will be appreciated that the inboard fitting 162a, 162b of the air line 160a, 160b can be adapted to open valves housed in valve stem 16, 26 when coupled to valve stem 16, 26. For example, inboard fittings 162a, 162b may be adapted to push the center pin of a Schrader valve to open the Schrader valve.

Air lines 160a, 160b may include an internal valve core, such as a Schrader valve core, disposed proximate the outboard ends. Outboard fittings 164a, 164b may thus be adapted such that when connected to the respective air fitting 150a, 150b, the outboard fitting 164, 164b opens the internal valve of the air line 160a, 160b. Air lines 160a, 160b may include a secondary port to which a tire pressure monitoring system may be connected to read the pressure in the air line and, hence, the pressure in the respective tire 14, 24. The secondary port may, in some embodiments, include an internal valve, such as a Schrader valve or other valve. Alternatively, or in addition, the secondary port may include another air fitting. By way of example, but not limitation, the secondary port may be protected by and be accessible through a valve cap 166a, 166b, such as a flow through valve cap designed for high pressure tractor-trailer tire service. In an even more particular embodiment, valve caps 166a, 166b are double sealed flow through valve caps. In another example embodiment, a conventional valve cap (one without a valve) is used to cover the secondary port when not in use.

In the illustrated embodiment, air fitting 150a, 150b includes a first fitting portion 152a, 152b and a second fitting portion 154a, 154b. First fitting portion 152a, 152b includes a valve stem portion that passes through mounting assembly 101 and into which a valve core 156a, 156b may be inserted. In one embodiment, each valve core 156a, 156b is a Schrader valve core. Second fitting portions 154a, 154b may screw onto or otherwise be coupled to the corresponding first fitting portion 152a, 152b. Thus, first fitting portion 152a, 152b and respective second fitting portion 154a, 154b form a valve body to house a respective valve core 156a, 156b.

The inboard ends of first fitting portion 152a, 152a is adapted to interface with outboard fitting 164a, 164b of the respective air line 160a, 160b. In one embodiment, for example, the inboard end of first fitting portion 152a, 152a comprises male threads such that a respective outboard fitting 164a, 164b can be screwed onto first fitting portion 152a, 152b.

FIG. 4A illustrates an exploded view of one embodiment of an air fitting 150 (e.g., air fitting 150a, air fitting 150b), comprising a first fitting portion 152, a second fitting portion 154, and a valve core 156. FIG. 4B illustrates a cross-sectional view of one embodiment of first fitting portion 152 (e.g., first fitting portion 152a, first fitting portion 152b). First fitting portion 152 is configured as an angled connector, incorporating a first section 176 and a second section 178. Although illustrated as a 45-degree fitting, the angular configuration of fitting 150 may vary to accommodate different installation requirements. The first fitting portion 152 defines an internal flow passage 155 extending from a first terminal end 172 to a second terminal end 174, facilitating controlled airflow through the fitting.

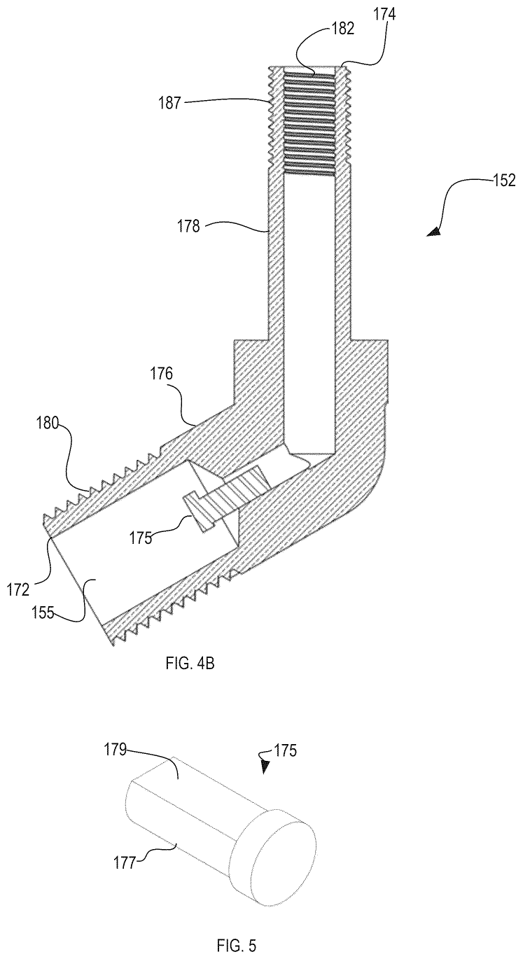

First section 176 is equipped with external threads 180 that are dimensioned to engage with the internal threads of an outboard air line fitting (e.g., outboard fitting 164a, 164b). In some implementations, the air line includes a valve at the outboard end. First section 176 may include a feature such as a pin 175 or other feature positioned in the interior cavity of first fitting portion 152 such that when the air line is connected to first section 176 the feature opens the valve in the airline. For example, pin 175 may press on the center pin of a Schrader valve to open the valve and hold the valve open while the airline is coupled to first section 176. In one embodiment, pin 175 is press-fit into a portion of the interior cavity of first fitting portion 152. As illustrated in FIG. 5, the shank 177 of pin 175 is shaped (e.g., with a flat face 179) to allow air in flow passage 155 to flow past pin 175.

The second section 178 functions as a valve stem and incorporates internal threads 182 near its distal end 174, which are adapted to engage with the external threads 184 of the valve core 156, thereby allowing valve core 156 to be securely threaded into the valve stem portion of first fitting portion 152. In certain embodiments, the valve stem portion (i.e., second section 178) is engineered to extend through structural components such as mounting bracket 104, base assembly 110 or the aerodynamic wheel cover 102. Additionally, second section 178 features external threads 187 to facilitate the attachment of the secondary fitting portion 154.

First fitting portion 152 may be bolted, welded, glued, epoxied, or otherwise mechanically, thermally, or chemically coupled to mounting bracket 104. In the embodiment illustrated, first fitting portion 152 further comprises an extension 185, such as a lug, having openings for mounting hardware to attach first fitting portion 152 to the inboard side of mounting bracket 104 or to provide surface area for welding, glueing, epoxying, etc. first fitting portion 152 to bracket 104. In other embodiments, first fitting portion 152 is coupled to mounting assembly 101 through mounting second fitting portion 154 to first fitting portion 152. First fitting portion 152 may include a retaining flange and key, such as discussed below. Other suitable mechanisms may also be used to retain first fitting portion 152 in a desired position.

Second fitting portion 154 defines an internal passage from a first end 188 to a second end 190. The section 192 proximate first end 188 is equipped with internal threads to engage with external threads 187 such that second fitting portion 154 can be screwed onto the outboard end of first fitting portion. In some embodiments, second fitting portion 154 abuts base assembly 110 when fully engaged to tighten fitting 150 onto mounting assembly 101. The section of second fitting portion 154 proximate to second end 190 includes external threads 194 to which the chuck of an air tool can be attached. Second fitting portion 154 is compatible with the internal valve of first fitting portion 152. Second fitting portion 154 may include a secondary valve, such as a flow through valve 186, that protects valve core 156 by preventing dirt and other debris from entering. In one embodiment, second fitting portion 154 is a flow through valve cap designed for high pressure tractor-trailer tire service. In an even more particular embodiment, second fitting portion 154 is a double seal flow through the valve cap.

In another example embodiment, a standard valve cap (one without a valve) is used to cover the accessible end of first fitting portion 152. The operator may remove the standard valve cap and engage the chuck of an air tool (e.g., an air hose for inflating a tire) directly to the outboard end of first fitting portion 152.

FIG. 6 illustrates one embodiment of the outboard end of an air line 160 (e.g., air line 160a, air line 160b) having an outboard fitting 164. In the illustrated embodiment, outboard fitting 164 is an internally threaded coupler that screws onto first section 176 of first fitting portion 152. The end portion 192 of air line 160 extends into first section 176 when air line 160 is connected to air fitting 150. End portion 192 of air line 160 may house a valve core, such as a Schrader valve core. A feature of the air fitting, such as pin 175, can press on the valve to hold the valve open while air line 160 is connected to the air fitting. FIG. 6 further illustrates one embodiment of a flow through valve cap 166 for a secondary port. Alternatively, or in addition, the secondary port may have an internal valve, such as an internal Schrader valve. In another example embodiment, a conventional valve cap (one without a valve) is used to cover the secondary port when not in use.

As discussed, aerodynamic wheel cover system 100 includes hub mounting assembly 101 to mount wheel cover 102 to the hub of a vehicle (e.g., hub 30). With reference to FIGS. 7-12, one embodiment of hub mounting assembly 101 comprises a mounting bracket 104 that mounts to a respective hub (e.g., hub 30) and a push-and-turn base assembly 110 that mounts to mounting bracket 104. Mounting bracket 104 may have a variety of form factors. In the illustrated embodiment, mounting bracket 104 comprises a pair of legs 106 that act as standoffs from the outboard surface of the hub. Feet 107 can include apertures for mounting hardware to mount mounting bracket 104 to a hub. Distal feet 107, a mounting platform 108 to which push-and-turn base assembly 110 mounts spans between legs 106. The mounting platform includes apertures to accommodate mounting hardware for mounting base assembly 110 to mounting bracket 104 and apertures 195 through which air fitting 150a, 150b, wires or other components can pass. While illustrated as a fixed bracket, mounting bracket 104 and other mounting brackets discussed herein may comprise multiple brackets and may be adjustable brackets such that the distance between the base assembly and the hub is adjustable. Non-limiting examples of adjustable brackets are described in U.S. Pat. No. 11,220,132, entitled, “Aerodynamic Wheel Covers and Mounting Assemblies,” issued Jan. 11, 2022, which is hereby fully incorporated by reference herein.

The mounting bracket may also be used to attach components such as, but not limited to: a Tire Pressure Monitoring System (TPMS); a power source; a receiver to receive data such as tire pressure, temperature, if one or more lug nuts are loose, treadwear, if a tire is out of balance or other data from sensors, an onboard computer, or other data sources; an input device to receive user input based on interaction with the input device; an output device or transmitter that displays or transmits data such as tire pressure, temperature, if one or more lug nuts are loose, treadwear, if a tire is out of balance, video images of the wheel cover system or wheel assembly, digital odometer readings, recommended maintenance schedule/items, advertising information, or other data; a camera that is positioned to monitor various components inboard or outside the wheel cover, such as components of the wheel assembly or wheel cover system, and transmit images or video (e.g., for inspections performed by an operator remotely or automatically by artificial intelligence or other means); a visible indicator such as a blinking light that indicates if tire pressure, temperature, or other data is within normal operating range or out of normal operating range; an auditory signal device such as a speaker that produces a desired sound to alert an operator of an issue such as data from a sensor outside of normal operating range; or a solar cell to maintain power. As previously described, the wheel cover 102 is configured for removable engagement with the base assembly 110 via a push-and-rotate mechanism. The push-and-turn base assembly 110 comprises a base 114, a piston 116, and an alignment member 118. Piston 116 includes a ring structure 119 concentrically positioned around a central shaft 120, with ring 119 connected to shaft 120 via a series of radially oriented spokes 122, which are interspersed with apertures 123 to facilitate component integration. Ring 119 further incorporates a series of notches 124 delineated by intervening ribs 126. Base 114 features outwardly extending projections 127 that are dimensioned to interface with apertures 123 between spokes 122, with the gaps between extensions 127 accommodating the spoke geometry. Additionally, base 114 includes apertures 147 (see FIG. 11) that permit passage of portions of the respective air fittings 150a, 150b, electrical wiring, or other ancillary components. Due to the interlocking configuration of extensions 127 within apertures 123, these components also traverse piston 116 without obstruction.

Alignment member 118 may be bolted, welded, glued, epoxied, or otherwise mechanically, thermally, or chemically coupled to base 114 to inhibit movement of alignment member relative to base 114. In the illustrated embodiment, bolts 125 pass through alignment member 118, base 114, and mounting platform 108 and are secured to mounting platform 108 with nuts 137 (FIG. 3).

Alignment member 118 can be a relatively flat sheet piece having radially extending arms 130 separated by notches 132 and having an aperture 129 to accommodate central shaft 120. Base 114 and alignment member 118 comprise apertures 141, 143 (FIG. 11 and FIG. 12) that can be aligned such that hardware, such as bolts 125, can be inserted to hold alignment member 118 relative to base 114. Alignment member 118 further includes radially extending arms 130 separated by notches 132. Arms 130 align with notches 124 in piston 116 and ribs of piston 116 align with notches 132 of alignment member. Alignment member 118 includes apertures 148 (FIG. 12) that align with apertures 147 of base 114 (FIG. 11) to permit passage of portions of the respective air fittings 150a, 150b, electrical wiring, or other ancillary components.

Although not shown, a biasing member, such as a spring may be disposed in inner shaft 120 and pressed against base 114 (e.g., in the inner area 128) to bias piston 116 away from base 114. The biasing member can bias piston 116 toward alignment member 118 such that ribs 126 are received in notches 132 and radially extending arms 130 are received in notches 124.

Wheel cover 102 includes a concentric inner ring 140 for coupling wheel cover 102 to base assembly 110. Inner ring 140 is coupled to a radially extending disk portion 146. In some embodiments, inner ring 140 comprises a plate of rigid material that is attached to disk portion 146 by hardware, welding, adhesive or other attachment mechanism. In other embodiments, inner ring 140 and disk portion 146 are formed as a single part. In some embodiments, wheel cover 102 provides a substantially continuous surface to facilitate aerodynamic flow around a wheel. In other embodiments, disk 146 may be configured to facilitate aerodynamic flow through the wheel cover, whereby the wheel cover may act as a fan or radial vent, for example. The size, rigidity, concavity/convexity, surface texture, venting features, or contact area with wheel(s) may be selected to promote a desired air flow around the wheel(s). Furthermore, in some embodiments, at least a portion of wheel cover 102 is manufactured with clear material or with openings to allow visual access to components of the wheel(s). In some embodiments, a removable center cap 103 is provided to cover the center of wheel cover 102 and base assembly 110. Center cap 103 may include apertures through which air fittings 150a, 150b pass. In some embodiments, center cap 103 includes a center aperture to align with the end of piston 116 (e.g., the outboard end of central shaft 120 (FIG. 10)) to allow the user to actuate piston 116 of a push-and-turn base assembly 110.

Further, center cap 103, or other portion wheel cover 102, or wheel cover assembly 100 may include components such as, but not limited to: power components such as batteries or a solar cell to provide power to electronic components mounted to wheel cover assembly 100 or the wheel; electronics or other components of a TPMS, a receiver to receive data such as tire pressure, temperature, if one or more lug nuts are loose, treadwear, if a tire is out of balance or other data from sensors, an onboard computer, a camera that is positioned to monitor various components inboard or outside the wheel cover, such as components of the wheel assembly or wheel cover system, or other data sources; an input device to receive user input based on interaction with the input device; an output device or transmitter that displays or transmits data such as tire pressure, temperature, if one or more lug nuts are loose, treadwear, if a tire is out of balance, video or images of components of the wheel cover system or wheel assembly, digital odometer readings, recommended maintenance schedule/items, advertising information or other data; a visible indicator such as a blinking light that indicates if tire pressure, temperature, or other data is within normal operating range or out of normal operating range; an auditory signal device such as a speaker that produces a desired sound to alert an operator of an issue such as data from a sensor outside of normal operating range; or a solar cell (e.g., on center cap 103) to maintain power.

Inner ring 140 includes tabs 142 that extend radially inward, separated by notches 144. Tabs 142 are sized to fit through notches 132 and notches 144 are sized to accommodate ribs 126. To install wheel cover 102, the user aligns tabs 142 with notches 132 and pushes wheel cover 102 inboard, causing tabs 142 to press against the outboard faces of ribs 126, thereby causing piston 116 to move inboard. Alternatively, the user may press the end of central shaft 120. Once piston 116 is depressed a sufficient amount to create a gap between the outboard surface of tabs 142 and the inboard surface of arms 130, wheel cover 102 can be rotated so that tabs 142 pass to the inboard side of arms 130. When sufficiently rotated, notches 144 fully align with ribs 126 such that the biasing member causes piston 116 to move outboard. Ribs 126 may thus shift to pass through notches 132 and notches 144, thereby locking wheel cover in place.

Additional example embodiments of wheel covers and mounting assemblies and the operation of a push-and-turn mounting mechanisms for mounting wheel covers are described in U.S. Pat. No. 11,220,132, entitled, “Aerodynamic Wheel Covers and Mounting Assemblies,” issued Jan. 11, 2022, which is hereby fully incorporated by reference herein.

The air fittings of air delivery system 105 may have a variety of form factors. Further, in some embodiments the air fittings may pass through the wheel cover without traversing through the base assembly.

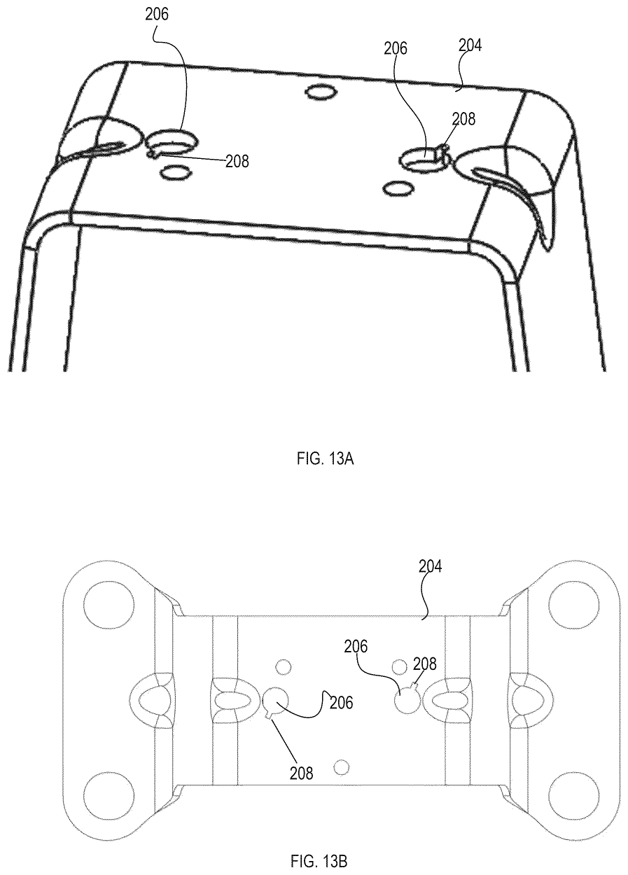

In some embodiments, an air fitting is utilized in association with a keyhole (e.g., a hole shaped to secure the air fitting) to lock onto a mounting bracket of the wheel cover system. FIGS. 13-19, for example, depict embodiments of aerodynamic wheel cover systems including air fittings with keyhole slots. These embodiments may include embodiments comprising fittings for air lines which utilize a key/key slot mechanism to lock onto the mounting bracket or base assembly. The fittings include provisions for mounting an air line to one side and may have internal and external threads to allow for a Schrader valve and secondary air fitting, such as, but not limited to, an air fitting with a flow through valve. In some embodiments, the air fittings bolt together.

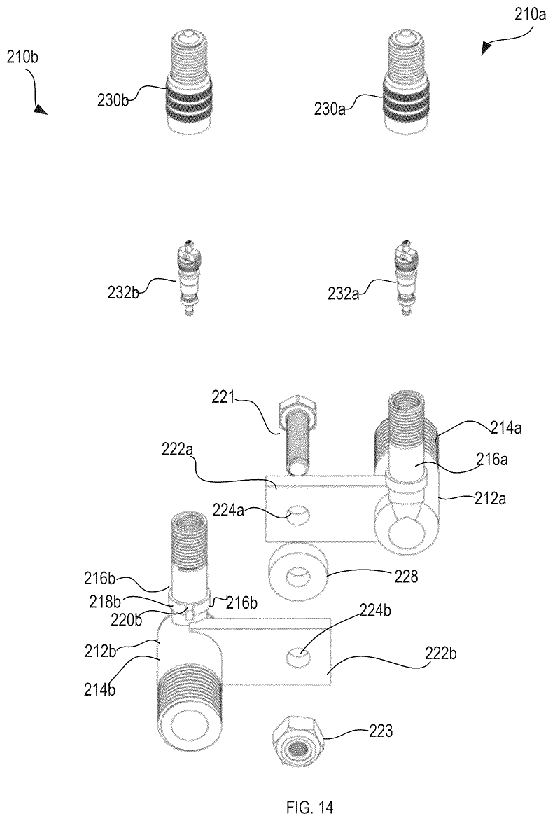

FIGS. 13A and 13B illustrate a mounting bracket 204 that includes apertures 206 with keyhole slots 208. Apertures 206 can be adapted to receive keyed air fittings. FIG. 14 illustrates one embodiment of air fittings (e.g., air fitting 210a and air fitting 210b) utilized in association with keyholes. Air fittings 210a, 210b include a first fitting portion 212a, 212b, a second fitting portion 230a, 230b, and a valve core 232a, 232b. According to one embodiment, valve cores 232a, 232b are Schrader valve cores. Second fitting portions 230a, 230b may include external threads to which the chuck of an air tool may be attached. Second fittings 230a, 230b may include secondary valves, such as, but not limited to, flow through valves. In one embodiment, second fitting portions 230a, 230b are flow through valve caps. In an even more particular embodiment, second fitting portions 230a, 230b are double sealed flow through valve caps.

In another example embodiment, standard valve caps are used to cover the accessible ends of first fitting portions 212a, 212b. In operation, the operator may remove the standard valve cap and engage the chuck of an air tool (e.g., an air hose for inflating a tire) directly to the outboard end of a first fitting portion 212.

First fitting portions 212a, 212b are right angle fitting portions and include a first section 214a, 214b and a second section 216a, 216b. The first sections 214a, 214b are adapted to connect to air lines in a similar manner as first section 176 of first fitting portion 152. Second sections 216a, 216b may act as valve stems into which valve cores 232a, 232b can be inserted. Second sections 216a, 216b have respective radial flanges 218a, 218b with a respective key (only key 220b is shown). Attachment flanges 222a, 222b extend from respective first sections 214a, 214b and include apertures 224a, 224b through which attachment hardware 221 can be inserted.

According to one embodiment, second section 216a of first fitting portion 212a may be inserted into one of the apertures 206 with the key of flange 218a aligned with the respective key slot 208. When the key passes through the key slot 208, the first fitting portion 212a can be rotated so that the key no longer overlaps the key slot. In this orientation, first fitting portion 212 is prevented from being pulled out of the aperture 206. Similarly, second section 216b of first fitting portion 212b may be inserted into the other apertures 206 with the key 220b of flange 218b aligned with the respective key slot 208. When the key 220b passes through the key slot 208, first fitting portion 212b can be rotated so that the key 220b no longer overlaps the key slot, thus preventing first fitting portion 212b from falling out.

Each of first fitting portions 212a, 212b can thus be rotated from a first orientation in which the respective key is aligned with a key slot to a second position in which the key is no longer aligned with the key slot. In particular, first fitting portions 212a, 212b can be rotated to second orientations in which attachment flanges 222a, 222b are parallel with apertures 224a, 224b aligned. Thus, hardware 221, such as a bolt, can be inserted through apertures 224a, 224b and secured (e.g., with nut 223).

In some embodiments, first fitting portions 212a, 212b have a common design. In such an embodiment, apertures 206 may be offset to allow first fitting portions 212a, 212b to rotate into the position in which attachment flanges 222a, 222b are parallel with apertures 224a, 224b aligned. This may result in a gap between attachment flanges 222a, 222b. A spacer 228 may be provided to span the gap between the flanges 222a, 222b.

In other embodiments, apertures 206 are positioned so that when air fittings 210a, 210b are rotated to their final installed positions, flanges 222a, 222b rotate together without a gap between their facing surfaces. In yet another embodiment, first fitting portion 212a, 212b have different designs such that the attachment flange 222a, 222b of one is spaced further from the axis of rotation (e.g., further from the axis defined by second section 216a, 216b) compared to the attachment flange of the other. For example, attachment flange 222b may be further from second section 216b along section 214b compared to the distance of attachment flange 222a along section 214a from second section 216a. Thus, when first fitting portions 212a, 212b are rotated, attachment flanges 222a, 222b may swing completely together.

When the aerodynamic wheel cover system is fully assembled, second sections 216a, 216b can pass through apertures 206 in mounting bracket 204, the base of a base assembly, a piston and alignment member. Thus, second fitting portions 230a, 230b can be accessible when a wheel cover is mounted to the mounting assembly.

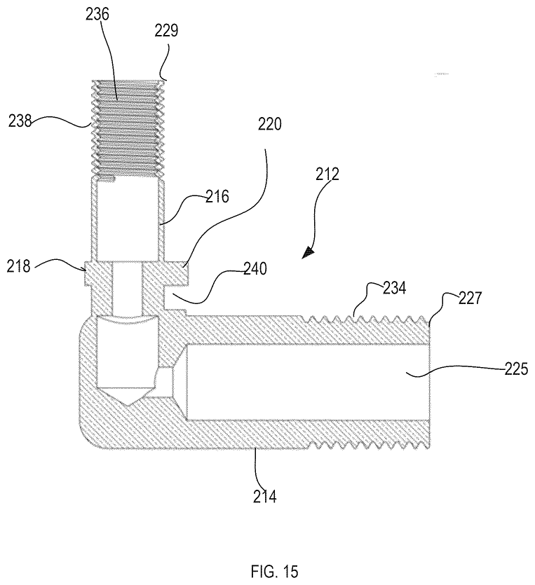

FIG. 15 illustrates a cross-sectional view of one embodiment of first fitting portion 212 (e.g., first fitting portion 212a, first fitting portion 212b). First fitting portion 212 defines a flow passage 225 from a first end 227 to a second end 229. First fitting portion 212 is an angled fitting having a first section 214 and a second section 216. While first fitting portion 212 is illustrated as a 90-degree fitting, first fitting portion 212 may be otherwise angled (e.g., as a 45-degree fitting or otherwise angled fitting).

First section 214 includes external threads 234 that are adapted to mate with the internal threads of an air line's outboard fitting (e.g., outboard fitting 164a, 164b). Second section 216 acts as a valve stem and includes internal threads 236 proximate second end 229 that are adapted to engage with external threads of a valve core (e.g., valve core 232a, valve core 232b). Thus, a valve core can be screwed into the valve stem section of first fitting portion 212. In some embodiments, the valve stem portion (e.g., second section 216) is adapted to pass through base assembly 110 or wheel cover 102. Second section 216 includes external threads 238 for attaching a second fitting portion (e.g., second fitting portion 230a, second fitting portion 230b).

Second section 216 further comprises a radial flange 218 having a feature that acts as a key 220. Key 220 is shaped to fit through a key slot 208 of mounting platform 204. When first fitting portion 212 is rotated, key 220 will prevent first fitting portion 212 from backing out of the aperture 206 by the portion of mounting platform disposed in notch 240 between key 220 and first section 214.

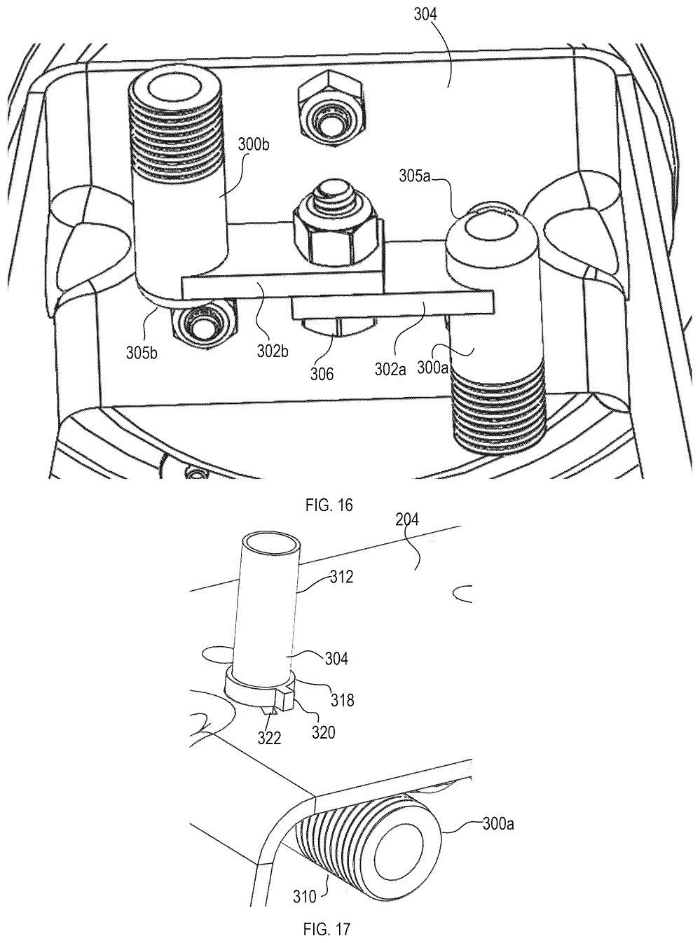

FIG. 16, for example, illustrates a view from the inboard side of an embodiment in which first fitting portions 300a, 300b are mounted to a mounting bracket 204. While first fitting portions 300a, 300b are illustrated as 90-degree fittings, first fitting portions 300a, 300b may be otherwise angled (as 45-degree fittings or otherwise angled fittings). First fitting portions 300a, 300b may be similar to first fitting portions 212a, 212b, but have attachment flanges 302a, 302b in different locations (e.g., attachment flange 302a is farther from end 305a than attachment flange 302b is from end 305b). When first fitting portions are inserted through the apertures of mounting bracket 304 with their keys aligned with the key slots and then rotated, attachment flanges 302a, 302b rotate completely together with their attachment hardware apertures aligned. Attachment hardware 306 (e.g., a bolt and washer) is used to hold the attachment flanges 302a, 302b together.

FIG. 17 illustrates a view from an outboard side of bracket 304. First fitting portion 300a includes a first section 310 and a second section 312. First section 310 may include a valve opening pin (e.g., a valve opening pin 175) or other feature to open an internal valve of a connected air line. Second section 312 may be a valve stem portion and include internal threads for screwing in a valve core and external threads (not shown in FIG. 17) for attaching the chuck of an air tool or a second fitting portion, such as a flow through valve fitment (e.g., second fitting portion 230a, second fitting portion 230b), a standard valve cap, or other component. Second section 312 includes a radial flange 318 with key and may be inserted through an aperture in bracket 304 with key 320 aligned with a key slot 322. Once key 320 has passed all the way through key slot 322, first fitting portion 300a can be rotated to a final position such that attachment key 320 is in the position illustrated in FIG. 17.

When assembled, second sections 312 of first fitting portions 300a, 300b can pass through apertures in mounting bracket 304, the base of a base assembly, a piston and alignment member. Thus, the ends of second sections 312 or second fitting portions attached thereto can be accessible when a wheel cover is mounted to the mounting assembly.

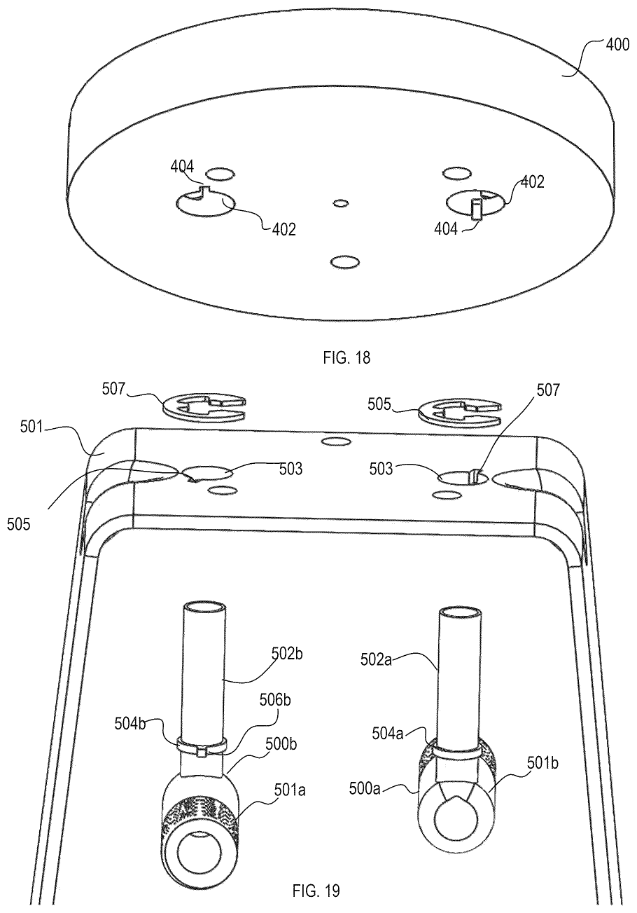

In some embodiments that use a flange and key arrangement, the inboard side of the base assembly may be shaped to accommodate such features, such that the base can sit flush against the mounting platform. FIG. 18, for example, illustrates the inboard side of one embodiment of a base 400 of a push-and-turn base assembly. The outboard side of base 400 may be similar to the outboard side of base 114. The inboard ends of the apertures 402 through which the air fittings pass may be sized and include a key slot 404 to accommodate, for example, a radial flange 218 and key 220 or radial flange 318 and key 320 to allow base 400 to be mounted flush against the mounting platform.

FIG. 19 depicts an embodiment of an aerodynamic wheel cover system that includes keyhole slots and circlips. In this embodiment, fittings for air lines connecting tractor tires to an accessible location through the wheel cover system are disclosed where the fittings are held onto the mounting bracket with a circlip. The fitting has a keyhole shape which restricts rotation when mounted on the mounting bracket.

In the embodiment of FIG. 19, first fitting portions 500a and 500b include sections 501a, 501b and sections 502a, 502b. While first fitting portions 500a, 500b are illustrated as 90-degree fittings, first fitting portions 500a, 500b may be otherwise angled (e.g., as 45-degree fittings or otherwise angled fittings). Sections 501a, 501b may include a valve opening pin (e.g., a valve opening pin 175) or other feature to open an internal valve of a connected air line. Sections 502a, 502b include radial flanges 504a, 504b with keys (only key 506b is shown). Fitting first portions may be similar to first fitting portions 212a, 212b without attachment flanges 222a, 222b. Although not shown, sections 502a, 502b may be valve stems similar to second sections 216a, 216b and include internal threads to engage a valve core and external threads to allow attachment of an air tool, a second fitting portion, such as a flow through valve fitting (e.g., second fitting portion 230a, second fitting portion 230b) or a standard valve cap. In this embodiment, sections 502a, 502b are inserted through apertures 503 in mounting bracket 501 with the keys aligned with key slots 505. Once the keys are through key slots 505, first fitting portions 500a, 500b can be rotated to their final positions. Retaining clips 507, such as circlips, that snap around sections 502a, 502b can be inserted between the flanges 504a, 504b and the outboard surface of bracket 501 to retain first portions 500a, 500b.

When the aerodynamic wheel cover system is fully assembled, sections 502a, 502b can pass through apertures 503 in mounting bracket 501, the base of a base assembly, a piston and alignment member. Thus, the outboard ends of sections 502a, 502b or second fitting portions attached thereto can be accessible when a wheel cover is mounted to the mounting assembly.

In some embodiments then, an aerodynamic wheel cover system includes a keyhole slot bracket (e.g., bracket 204, bracket 304) and corresponding base assembly (e.g., with base 400). Fittings for air lines connecting to an accessible location through a wheel cover system may fit through the keyhole in the mounting bracket. In some embodiments, the base assembly has a feature to lock the fittings in place.

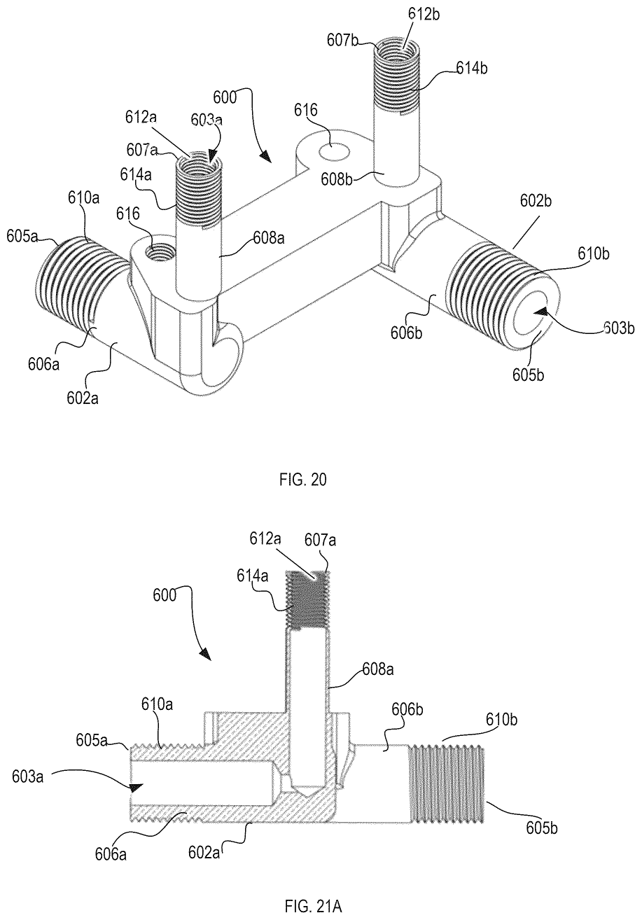

FIGS. 20-22 depict embodiments of aerodynamic wheel cover systems including a single piece fitting. In these embodiments, single one-piece fittings for air lines connecting tractor tires to an accessible location through a wheel cover assembly are disclosed where the fitting mounts to the wheel cover mounting bracket and goes through the center of the wheel cover and allows the wheel cover to be removed without affecting air line accessibility.

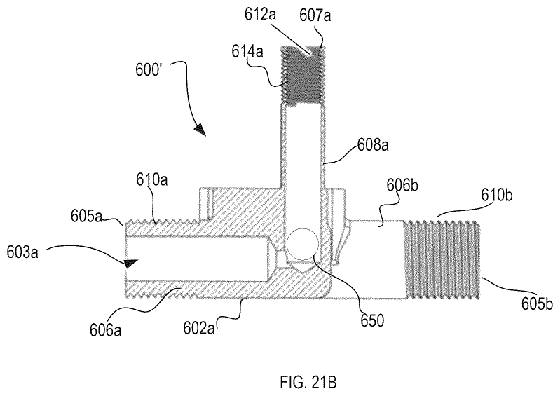

FIG. 20 illustrates one embodiment of a junction 600 in which in a pair of first fitting portions 602a, 602b are formed as a monolithic device. FIG. 21A is a cross-sectional view of junction 600. Each of the first fitting portions 602a, 602b defines a flow passage 603a, 603b from a first end 605a, 605b to a second end 607a, 607b. According to one embodiment, flow passages 603a, 603b are segregated from each other. In another embodiment, the flow passages are connected to each other. First fitting portions 602a, 602b are angled fittings having a first section 606a, 606b and a second section 608a, 608b. While first fitting portions 602a, 602b are illustrated as 90-degree fittings, first fitting portions 602a, 602b may be otherwise angled (e.g., 45 degree otherwise angled fittings).

First section 606a, 606b includes external threads 610a, 610b that are adapted to mate with the internal threads of the air line's outboard fitting (e.g., outboard fitting 164a, 164b). First sections 606a, 606b may include a valve opening pin (e.g., a valve opening pin 175) or other feature to open an internal valve of a connected air line. Second sections 608a, 608b act as valve stems and include internal threads 612a, 612b proximate second ends 607a, 607b. Internal threads 612a, 612b are adapted to mate with external threads of a valve core, such as valve core 156. Thus, a valve core can be screwed into the valve stem sections of first fitting portions 602a, 602b. In some embodiments, the valve stem portion (e.g., second section 608a, 608b) is adapted to pass through base assembly 110 or wheel cover 102. Second section 608a, 608b includes external threads 614a, 614b for attaching a second fitting portion, such as a second fitting portion 154a, 154b. Junction 600 includes a lug or other portion having openings 616 to accommodate mounting hardware for attaching junction 600 to a mounting bracket.

FIG. 21B illustrates another embodiment of a junction 600′ similar to junction 600. In junction 600′ flow passages 603a, 603b (flow passage 603b is illustrated in FIG. 20) are connected by a connecting passage 650 and thus share a flow passage. Thus, air can be added via either second section 608a, 608b (section 608b is illustrated in FIG. 20) to add air to both tires. Thus, in operation, one of the second sections 608a, 608b can remain capped. Further, in some embodiments, one of the second sections 608a, 608b is omitted such that first sections 606a, 606b connect to a common accessible portion. The second section, in such an embodiment, may be centered or otherwise positioned between the first sections 606a, 606b.

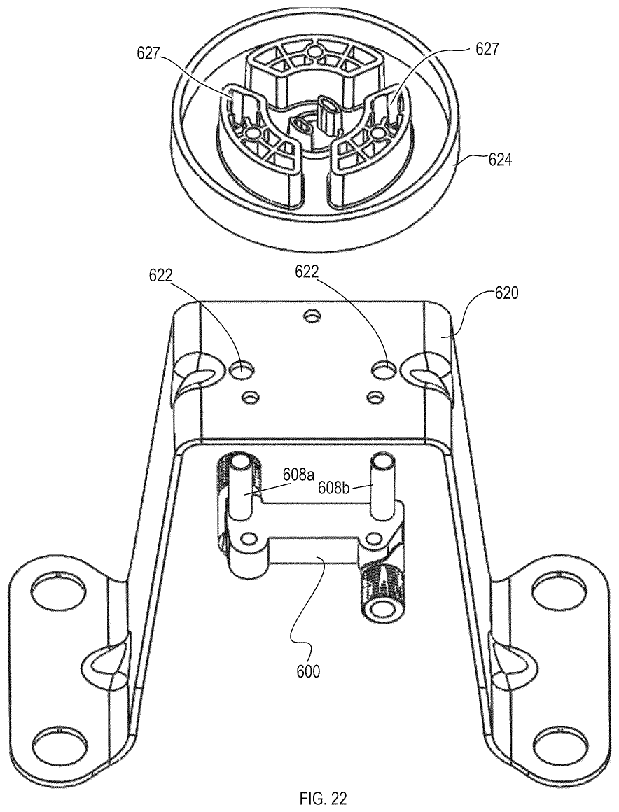

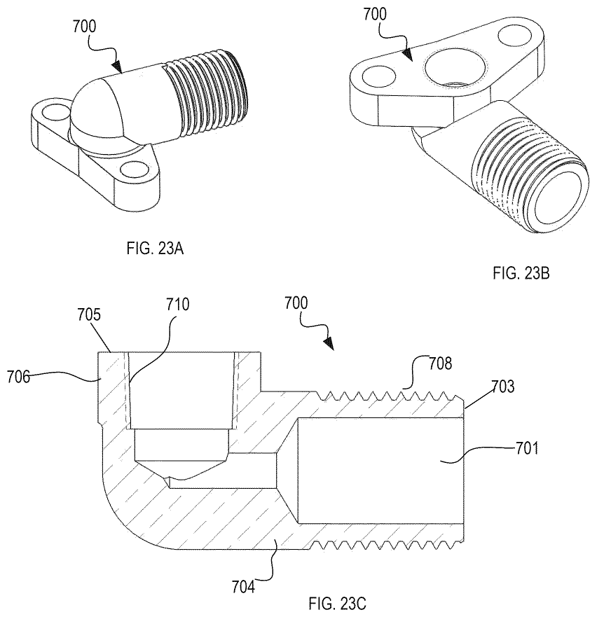

FIG. 22 illustrates one embodiment of mounting junction 600 to a bracket 620. Junction 600 can be attached (e.g., bolted or otherwise attached) to the inboard side of mounting bracket 620 with second sections 608a, 608b passing through apertures 622. A base 624, which may be similar to base 114, can be mounted to mounting bracket 620 with apertures 627 aligned with apertures 622 so that second sections 608a, 608b pass through base 624 and similarly through the piston and alignment member.

When the aerodynamic wheel cover system is fully assembled, second sections 608a, 608b can pass through apertures 503 in mounting bracket 501, the base of a base assembly, a piston and alignment member. Thus, the outboard ends of sections 502a, 502b or second fitting portions attached thereto can be accessible when a wheel cover is mounted to the mounting assembly.

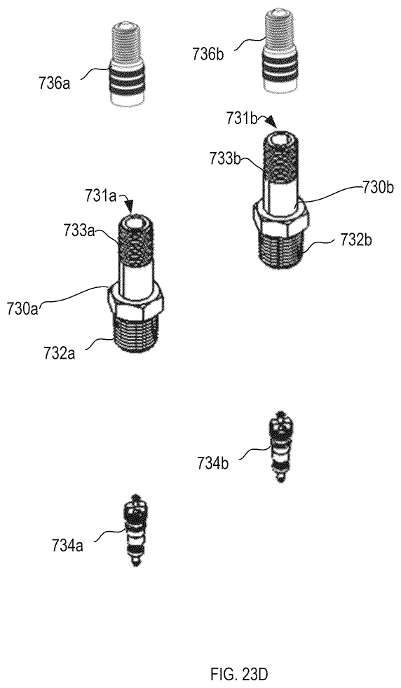

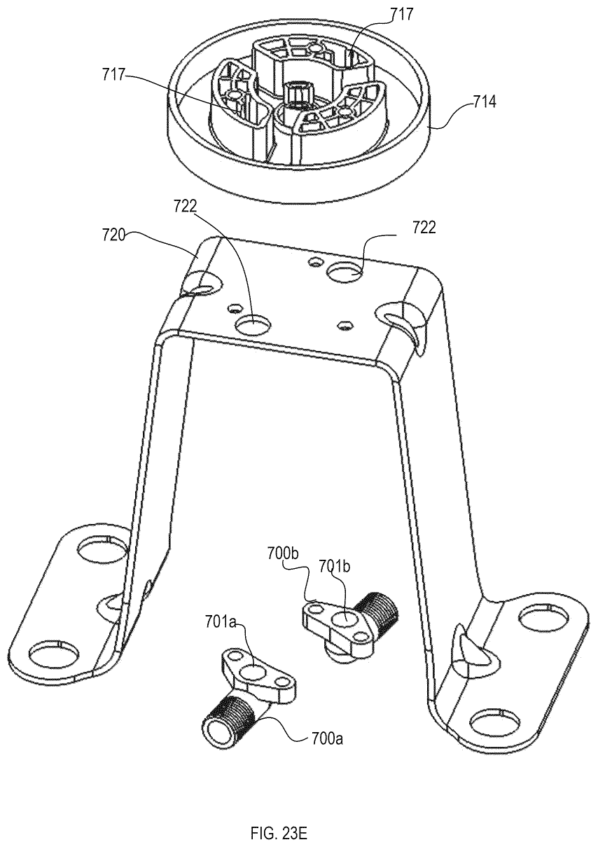

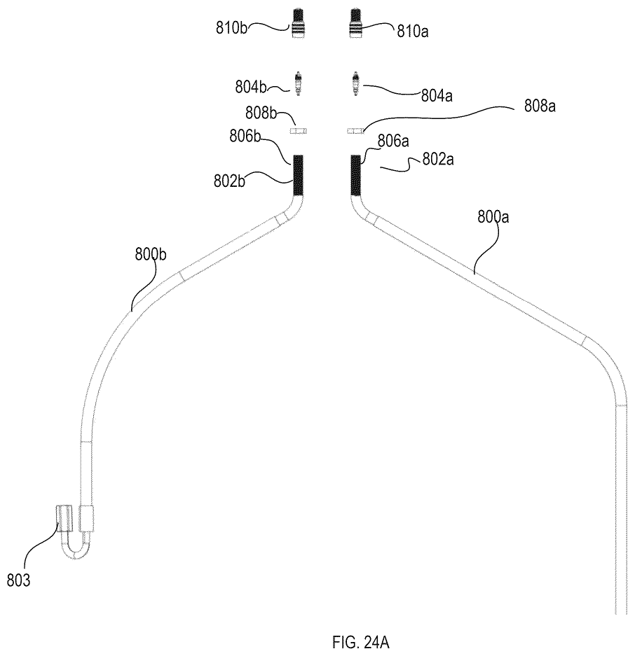

FIGS. 23A-23E depict embodiments of aerodynamic wheel cover systems including 90-degree fittings with a bolt mount. In these types of embodiments, fittings for air lines connecting tractor tires to an accessible location through wheel cover assembly are disclosed where the fittings are held onto the mounting bracket with a fastener. This embodiment (and other embodiments) allows the wheel cover mechanism to operate normally and allows removal of the wheel cover if needed without affecting the air lines.

In the embodiments of FIGS. 23A-23E, the air fittings include a first fitting portion 700 (e.g., first fitting portion 700a, first fitting portion 700b). First fitting portion 700 defines a flow passage 701 from a first end 703 to a second end 705. First fitting portion 700 is an angled fitting having a first section 704 and a second section 706. While first fitting portion 700 is illustrated as a 90-degree fitting, first fitting portion 700 may be otherwise angled (e.g., as a 45-degree or otherwise angled fitting). First section 704 includes external threads 708 that are adapted to mate with the internal threads of the air line's outboard fitting (e.g., outboard fitting 164a, 164b). First section 704 may include a valve opening pin (e.g., valve opening pin 175) or other feature to open an internal valve of a connected air line. Second section 706 includes internal threads 710 to allow a valve stem section to be coupled to first fitting portion 700.

Turning to FIG. 23D, second fitting portions 730a, 730b are provided. Second fitting portions have an internal passage 731a, 731b and may include internal threads such that a valve core 734a, 734b may be secured in the internal passage 731a, 731b of second fitting portion 730a, 730b. Second fitting portions 730a, 730b include first externally threaded portions 732a, 732b adapted to mate with the internal threads (e.g., internal threads 710) of the corresponding first fitting portion 700a, 700b.

Second fitting portions 730a, 730b can include second externally threaded portions 733a, 733b to allow attachment of a respective third fitting portion 736a, 736b. Third fitting portions 736a, 736b include external threads to which an air tool may be attached. Third fitting portions 736a, 736b may comprise secondary valves, such as, but not limited to, flow through valves. For example, in one embodiment, third fitting portions 736a, 736b are flow through valve caps that include internal flow through valves. In some embodiments, third fitting portions 736a, 736b are double sealed flow through valve caps.

In another example embodiment, standard valve caps are used to cover the accessible ends of second fitting portions 730a, 730b. The operator may remove the standard valve cap and engage the chuck of an air tool (e.g., an air hose for inflating a tire) directly to the outboard end of a second fitting portion 730a, 730b.

With reference to FIG. 23E, first fitting portions 700a, 700a can be attached (e.g., bolted) to a mounting bracket 720 with the entrances to flow passages 701a, 701b aligned with a respective aperture 722. A base 714, which may be similar to base 114, can be mounted to mounting bracket 720 with apertures 717 aligned with apertures 722.

When the aerodynamic wheel cover system is fully assembled, second fitting portions 730a, 730b will thus extend through apertures 717 in base 714 and apertures 722 in bracket 720. Similarly, second fitting portions 730a, 730b can pass through the piston and apertures in an alignment member such that the third fitting portions 736a, 736b are accessible.

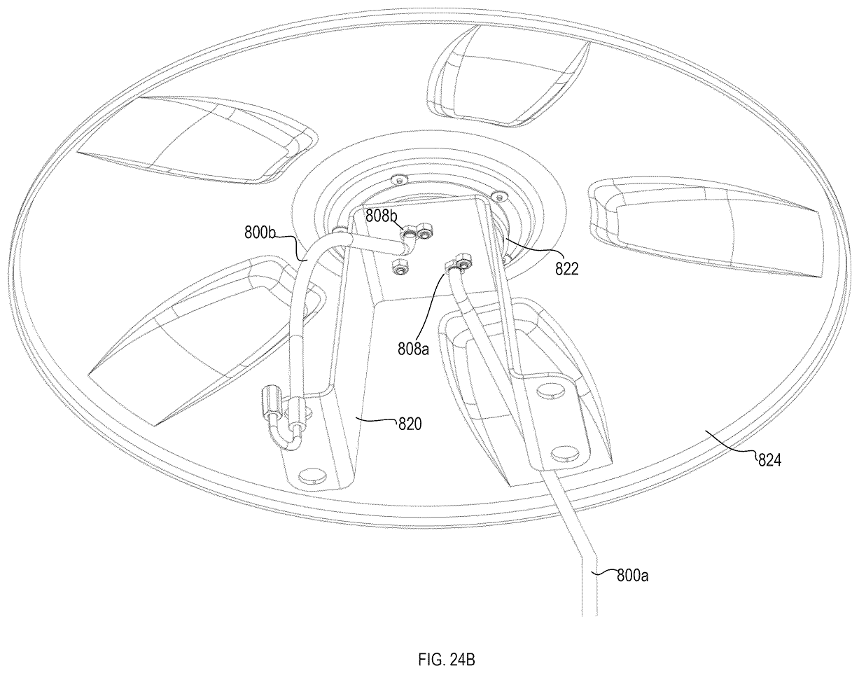

FIG. 24A illustrates another embodiment of providing accessibility to tire air lines. In the embodiment of FIG. 24A, air lines 800a, 800b include an inboard end fitting to connect to a respective tire valve stem (e.g., valve stem 16, 26). The inboard fitting for air line 800a is not illustrated but may be similar to inboard fitting 162a. Air line 800b includes inboard fitting 803 to connect to the outboard tire of a dual wheel arrangement. The inboard ends air lines 800a, 800b may be configured with a feature to keep the valves of valve stems 16, 26 open when airlines 800a, 800b are connected to valve stems 16, 26. The outboard ends 802a, 802b of air lines 800a, 800b are sized and internally threaded to accommodate valve cores 804a, 804b. According to one embodiment, valve cores 804a, 804b are Schrader valve cores. Thus, the outboard ends 802a, 802b may be fitted with internal valves. According to one embodiment, second ends 802a, 802b may be routed through a mounting bracket and base assembly. A mounting washer 808a, 808b may be coupled to air line 800a, 800b to retain air line 800a, 800b in place.

The outboard ends 802a and 802b may be equipped with integrated fittings. For example, these ends may feature external threads 806a, 806b designed to accommodate direct attachment of air tools, including but not limited to air hoses for inflating tires. Additionally, threaded fittings 810a, 810b may be secured onto threads 806a and 806b, respectively. These fittings may themselves possess external threads to facilitate further tool connections and may incorporate secondary valve mechanisms, such as flow-through valves. In a more particular embodiment, they are implemented as flow-through valve caps, including variants such as double-sealed flow-through valve caps.

In one embodiment, conventional valve caps may be threaded onto the external threads 806a and 806b to seal the exposed ends 802a and 802b of the air lines 800a and 800b. These caps can be removed by the operator to allow direct engagement of an air tool chuck—such as that of an inflation hose—with the outboard ends 802a and 802b.

Although not shown, air lines 800a, 800b may include a secondary port to which a tire pressure monitoring system may be connected to read the pressure in the air line and, hence, the pressure in the respective tire. The secondary port may, in some embodiments, include an internal valve, such as a Schrader valve or other valve. Alternatively, or in addition, the secondary port may include another air fitting. By way of example, but not limitation, the secondary port may be protected by and be accessible through a valve cap, such as a flow through valve cap designed for high pressure tractor-trailer tire service. In an even more particular embodiment, the valve caps are double sealed flow through valve caps.

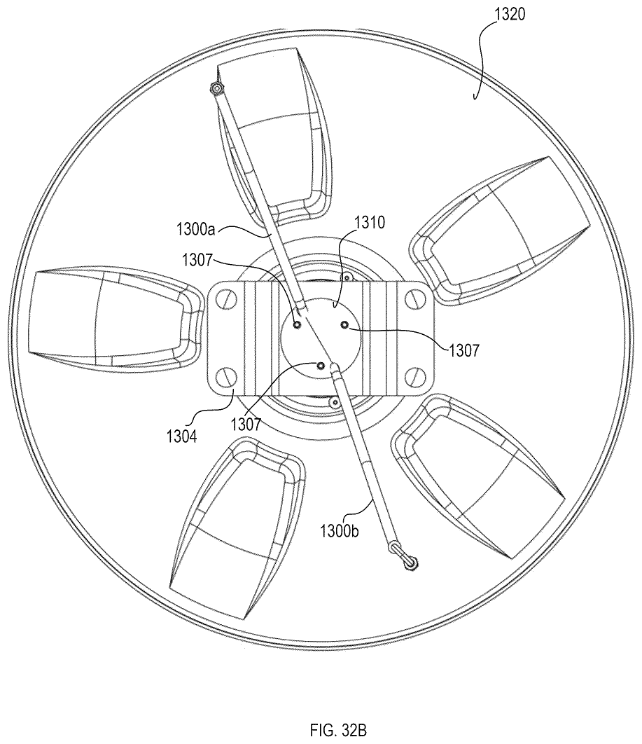

FIG. 24B illustrates an inboard view of one embodiment of an aerodynamic wheel cover system. In the embodiment of FIG. 24B a mounting bracket 820 is provided to mount the assembly to the hub of a vehicle. A base assembly 822 is mounted to mounting bracket 820 and wheel cover 824 is mounted to base assembly 822. The outboard ends of air lines 800a, 800b are routed through mounting bracket 820 and base assembly 822 such that they are accessible even when wheel cover 824 is mounted. FIGS. 32A-32B illustrate another embodiment of mounting air lines 1300a, 1300b.

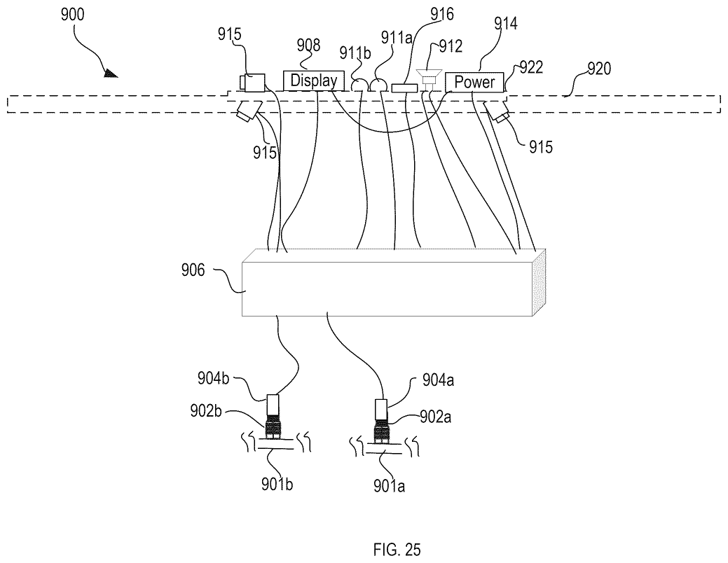

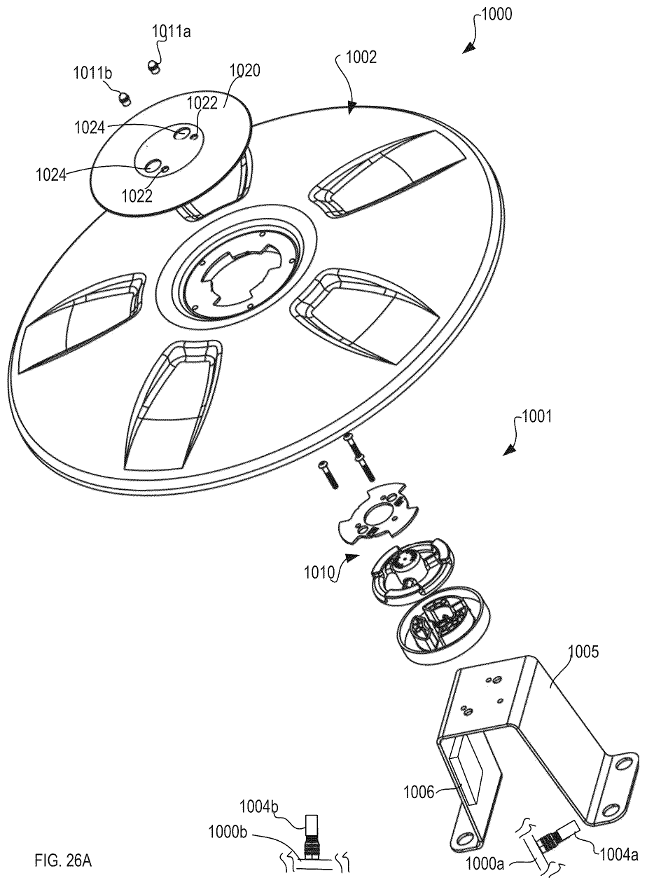

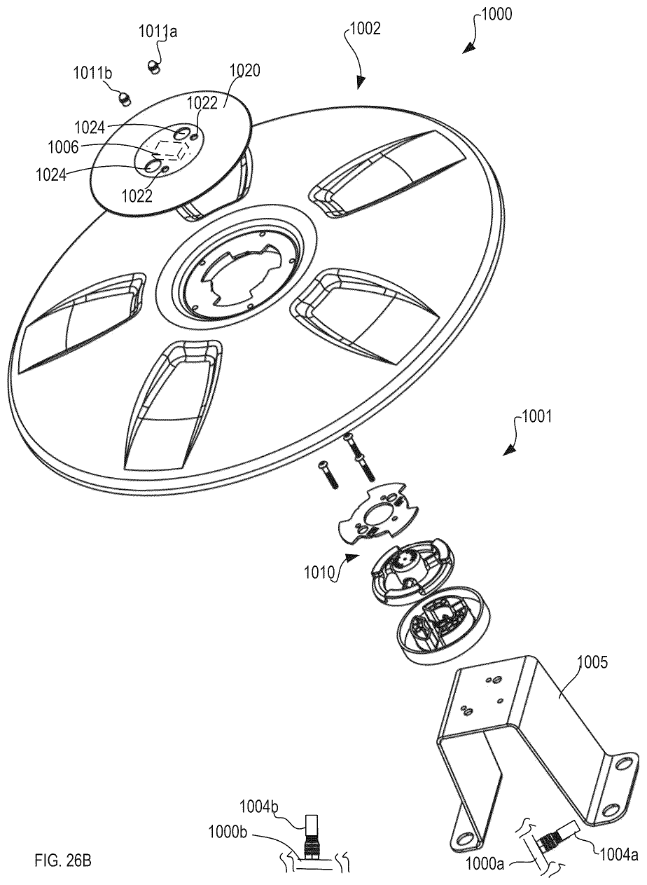

As discussed, an air line (e.g., air line 160a, 160b, 800a, 800b, 1300a, 1300b) may have a secondary port that may be used for pressure monitoring or for other purposes. FIG. 25 illustrates an embodiment of a wheel electronics system 900 in which air lines 901a, 901b include secondary ports 902a, 902b to which sensors 904a, 904b, such as TPMS sensors, are coupled to sense the pressure in air lines 901a, 901b, temperature or other conditions. Sensors 904a, 904b may communicate via a wired or wireless connection to an onboard controller 906, which may include a micro-computer or other control circuitry.

A wheel cover 920 is provided, which may be mounted to a wheel by a mounting assembly, such as, but not limited to, mounting assembly 101 or other mounting assemblies described herein. Wheel cover 920 may be an aerodynamic wheel cover, such as wheel cover 102. Wheel cover 920 includes a center cap 922. The center cap 922 may be configured to be removable from the wheel cover 920 or it may be configured to remain attached to the wheel cover 920.

Wheel cover 920—for example, center cap 922 of wheel cover 920 or other portion of wheel cover 920—or other portion of a wheel cover assembly may include components such as, but not limited to: power components such as batteries or a solar cell to provide power to electronic components mounted to the wheel cover assembly or the wheel; components of a TPMS; an onboard controller; sensors; a receiver to receive data such as tire pressure, temperature, if one or more lug nuts are loose, treadwear, if a tire is out of balance or other data from sensors, an onboard computer, or other data sources; a camera that is positioned to monitor various components inboard or outside the wheel cover, such as components of the wheel assembly or wheel cover system, for inspections performed by an operator remotely or automatically by artificial intelligence or other means; an input device to receive user input based on interaction with the input device; an output device or transmitter that displays or transmits data such as tire pressure, temperature, if one or more lug nuts are loose, treadwear, if a tire is out of balance, video or images of components of the wheel cover system or wheel assembly, digital odometer readings, recommended maintenance schedule/items, advertising information, or other data; a visible indicator such as a blinking light that indicates if tire pressure, temperature, or other data is within normal operating range or out of normal operating range; an auditory signal device such as a speaker that produces a desired sound to alert an operator of an issue such as data from a sensor outside of normal operating range.

In the embodiment illustrated, wheel cover 920 includes display 908, LEDs 911a, 911b, speaker 912, power source 914 (e.g., solar cell or batteries), a camera 915 and input device 916, which may be integrated with center cap 922 or other portion of wheel cover 920. Further, in some embodiments, LEDs 911a, 911b, display 908, speaker 912, camera, or power source 914 may be mounted elsewhere on a wheel, such as to the hub.

A camera (e.g., cameras 915) mounted to wheel cover, the mounting assembly (e.g., the legs or feet of the mounting bracket, on the inboard or outboard side of the mounting platform or a mounting bracket wing (e.g., a wing 1209a, 1209b) or elsewhere on the wheel assembly (e.g., the hub or rim). The camera may be positioned to monitor various components inboard or outboard of wheel cover 920, such as components of the wheel cover system or wheel assembly, and transmit images or video (e.g., for inspections performed by an operator remotely or automatically by artificial intelligence or other means).

LEDs, sensors, displays, cameras, speakers, controller 906, or other components may be powered by batteries, wired to a power source on the vehicle, or may be powered by solar energy. The sensors are preferably wireless and may be configured to provide one or more signals to one or more displays or other devices.

Onboard controller 906 may receive input signals from or transmit output signals via wired or wireless connections from or to sensors 904a, 904b, cameras 915, user input device 914, a display 908, individual LEDs 911a, 911b, a speaker 912 to provide control signals, receive input data and provide data to inform a user of various conditions. In some embodiments, onboard controller 906 communicates with an onboard computer system of a vehicle (e.g., through a wireless connection). Onboard controller 906 may have its own power supply (e.g., batteries) or be connected to power source 914 or vehicle power.

LEDs may be controlled to change color or may be turned off or on based on a detected pressure or other condition. In some embodiments, LEDs 911a, 911b blink to indicate that the tire pressure, temperature, or other data is within normal operating range or out of normal operating range. For example, LED 911a may be turned on or off or otherwise controlled based on the pressure or temperature read by sensor 904a and LED 911b may be turned on or off or otherwise controlled based on the pressure or temperature read by sensor 904b. The LEDs may be used to indicate whether any number of sensors are providing a signal within a given range. For example, the LED may be configured to blink red if the tire pressure is low, if the lug nuts are loose, or if the temperature is too high.

Furthermore, onboard controller 906 may output data for presentation by display 908. For example, display 908 may be used to display data such as tire pressure, temperature, if lug nuts are loose, treadwear, if a tire is out of balance, video or images from a camera 915 or other source, digital odometer readings, recommended maintenance schedule/items, advertising information, or other data. The display may be active some or all of the time, or only when a signal is outside of a given range. The display may be configured to be activated by an operator, such as with a button that illuminates the display when depressed.

Speaker 912 can be controlled to produce a desired sound to alert an operator of an issue such as data from a sensor outside of normal operating range. Input device 914 (e.g., button, knob, or another type input device) may be provided to allow a user to turn on/off display 908, cycle through information shown in display 908, check the status of tires via LEDs 911a, 911b or otherwise interact with a user interface.

Electronics system 900 is presented as a representative architecture, with the understanding that various embodiments may incorporate additional or fewer input/output interfaces depending on specific application requirements. This system architecture is compatible with multiple configurations of wheel cover assemblies, mounting assemblies and fittings as described herein. The onboard controller 906 may be affixed to a range of structural components, including but not limited to the hub, a mounting bracket, or the inboard surface of a wheel cover, such as, but not limited to the reverse side of a center cap.

The onboard controller 906 may include a wireless receiver for acquiring data from distributed sensors, and a processing unit, such as a central processing unit (CPU), application-specific integrated circuit (ASIC), or field-programmable gate array (FPGA), to interpret sensor data, user inputs (e.g., via input device 916), and to generate output signals for various output devices. These output devices may include a visual display 908, indicator LEDs 911a and 911b, and an audio transducer such as speaker 912. In certain implementations, these output components are physically and functionally integrated within the onboard controller 906 to streamline system architecture and reduce installation complexity.

Electronics system 900 may be used in conjunction with various fittings such as, but not limited to, air fittings 150a, 150b, 210a, 210b, 300a, 300b, 500a, 500b, 700a/730a, 700b/730b, air lines 800a, 800b, 1300a, 1300b, mounting assemblies, base assemblies, and wheel covers.

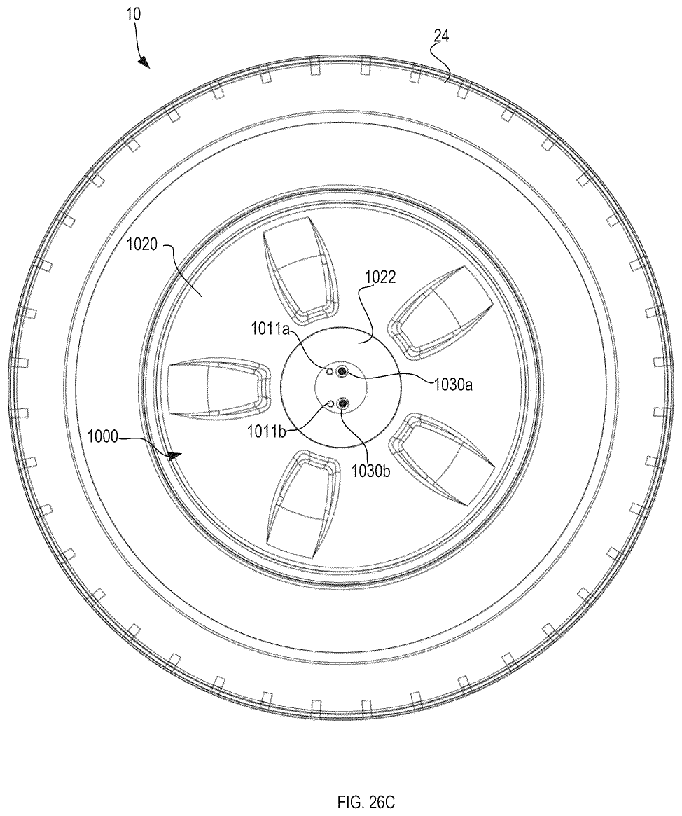

FIGS. 26A and 26B illustrate embodiments of aerodynamic wheel cover system 1000 used in conjunction with one embodiment of a wheel electronics system 900. FIG. 26C illustrates a side view of a wheel assembly with wheel cover 1002 mounted. Aerodynamic wheel cover system 1000 may include a mounting assembly 1001 and wheel cover 1002 similar to mounting assembly 101 and wheel cover 102. Mounting assembly 1001 may include air fittings (not shown in FIG. 26A) that have a portion that is accessible even when wheel cover 1002 is mounted. For example, wheel cover system 1000 may use air fittings 150a, 150b, 210a, 210b, 300a, 300b, 500a, 500b, 700a/730a, 700b/730b, air lines with integrated fittings (e.g., air lines 800a, 800b, 1300a, 1300b), or other air fittings.

Air lines 1000a, 1000b may be similar to air lines 160a, 160b, 800a, 800b, 1300a, 1300b and have inboard fittings that connect to the valve stems of tires, outboard fittings that connect to the air fittings of the wheel cover assembly, and secondary ports. In the embodiment illustrated, sensors 1004a, 1004b are coupled to the secondary ports of the air lines 1000a, 1000b. Sensors 1004a, 1004b may be TPMS sensors that wirelessly communicate pressure and temperature to onboard controller 1006. In FIG. 26A, onboard controller 1006 is mounted to mounting bracket 1005 (e.g., to a bracket leg, the back of the mounting platform or elsewhere). Signal lines may be routed through mounting bracket 1005, base assembly 1010 and wheel cover 1002 to connect to LEDs 1011a, 1011b. In another embodiment, as illustrated in FIG. 26B, onboard controller 1006 may be mounted to a center cap 1020 or other portion of wheel cover 1002. Signal channels, such as signal wires or traces, may connect LEDs 1011a, 1011b to other portions of onboard controller 1006 mounted, for example, directly behind LEDs 1011a, 1011b.

In some embodiments, LEDs 1011a, 1011b blink to indicate that the tire pressure, temperature, or other data is within normal operating range or out of normal operating range. For example, LED 1011a may be turned on or off or otherwise controlled based on the pressure or temperature read by sensor 1004a and LED 1010b may be turned on or off or otherwise controlled based on the pressure or temperature read by sensor 1004b. LEDs 1011a, 1011b may be located elsewhere on wheel cover 1002.

A center cap 1020 is provided to cover the center of wheel cover 1002. Center cap 1020 includes apertures 1022 in which LEDs 1011a, 1011b can be located and apertures 1024 to allow access to the accessible portions of the air fittings 1030a, 1030b, such as the flow through valve caps. LEDs 1011a, 1011b are visible and air fitting portions 1030a, 1030b are accessible to the user when wheel cover 1002 is mounted to the wheel with center cap 1020 in place. Further, center cap 1020 or other portion of wheel cover 1002 may include components such as, but not limited to power components such as batteries or a solar cell to provide power to electronic components mounted to the wheel cover assembly or the wheel; components of a TPMS; sensors; a receiver to receive data such as tire pressure, temperature, if one or more lug nuts are loose, treadwear, if a tire is out of balance or other data from sensors, an onboard computer, or other data sources; an input device to receive user input based on interaction with the input device; one or more cameras to capture images or video of components behind or outside of the wheel cover assembly; an output device or transmitter that displays or transmits data such as tire pressure, temperature, if one or more lug nuts are loose, treadwear, if a tire is out of balance, images or video from the camera, digital odometer readings, recommended maintenance schedule/items, advertising information, or other data; an auditory signal device such as a speaker that produces a desired sound to alert an operator of an issue such as data from a sensor outside of normal operating range.

In some embodiments, center cap 1020 a central aperture to align with the end of the piston (e.g., the outboard end of central shaft 120 (FIG. 10) to allow the user to actuate the piston.

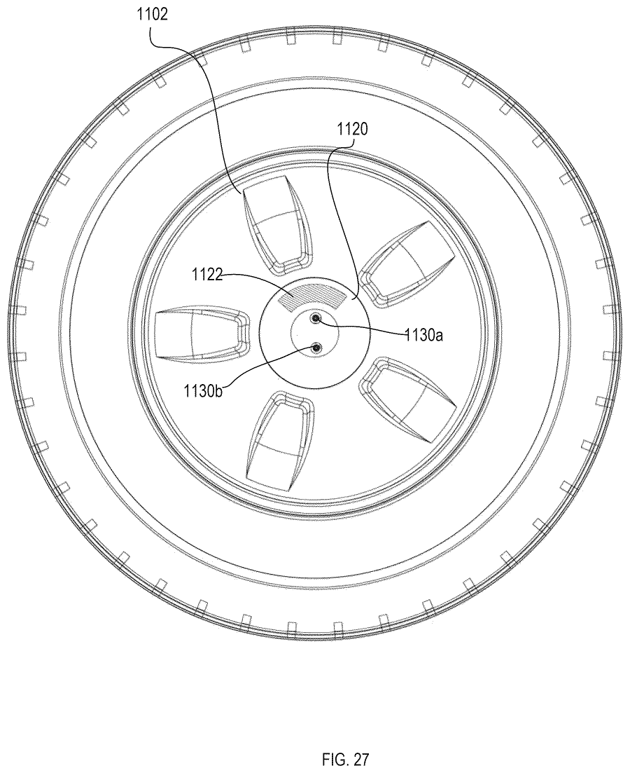

FIG. 27 illustrates an example embodiment in which wheel cover 1102 includes a center cap featuring an LED display 1122, which may represent one implementation of display 908. Wheel cover 1102 may be adapted to mount to a mounting assembly (e.g., mounting assembly 101, mounting assembly 1001 or other mounting assembly) and be used in conjunction with various types of air fittings. These may include, but are not limited to, air fittings 150a, 150b, 210a, 210b, 300a, 300b, 500a, 500b, 700a/730a, 700b/730b, air lines with integrated fittings (e.g., air lines 800a, 800b, 1300a, 1300b).

Signal channels (e.g., signal wires or traces) may connect display 1122 to onboard electronics (e.g., such as onboard controller 1006 mounted to the mounting bracket 1005, the inboard side of center cap 1120 or elsewhere). In some embodiments, display 1122 is mounted directedly to onboard electronics for receiving and processing signals from sensors, such as TPMS sensors 1004a, 1004b. For example, display 1122 may be an LCD or other display of an onboard controller mounted to wheel cover 1102—for example, mounted to the inboard side of center cap 1120. Display 1122 is visible and air fitting portions 1130a, 1130b are accessible to the user when wheel cover 1102 is mounted to the wheel. The display may be active some or all of the time, or only when a signal is outside of a given range. The display may be configured to be activated by an operator, such as with a button that illuminates the display when depressed. Display 1122 may display data such as tire pressure, temperature, if one or more lug nuts are loose, treadwear, if a tire is out of balance, video from one or more cameras, or other data.

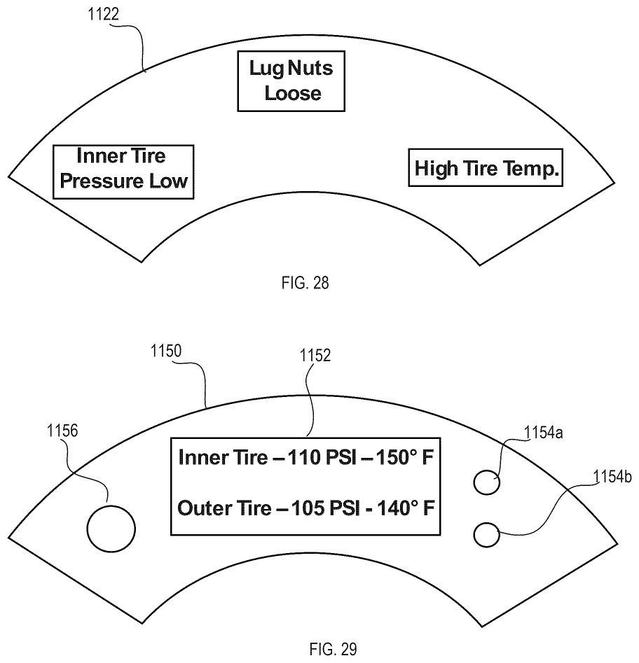

FIG. 28 is a diagrammatic representation illustrating example data displayed in display 1122.

FIG. 29 illustrates an alternative user interface 1150 that may be integrated with a wheel cover—for example, integrated into a center cap (e.g., center cap 1120) of a wheel cover. User interface 1150 includes a display portion to display data such as tire pressure, temperature, if one or more lug nuts are loose, treadwear, if a tire is out of balance, video from one or more cameras, digital odometer readings, recommended maintenance schedule/items, advertising information, or other data. LEDs 1154a, 1154b blink, change color, or otherwise visibly indicate if tire pressure, temperature, or other data is within normal operating range or out of normal operating range. For example, the LED may be configured to blink red if the tire pressure is low, if the lug nuts are loose, or if the temperature is too high. LED 1154a may be responsive, for example, to data about the inner tire and LED 1154b may be responsive to data about the outer tire. An input device 1156 (e.g., button, knob, or other input device) may be provided to allow a user to turn on/off display 1152, cycle through information in display 1152, check the status of tires via LEDs 1154a, 1154b or otherwise interact with user interface 1150.

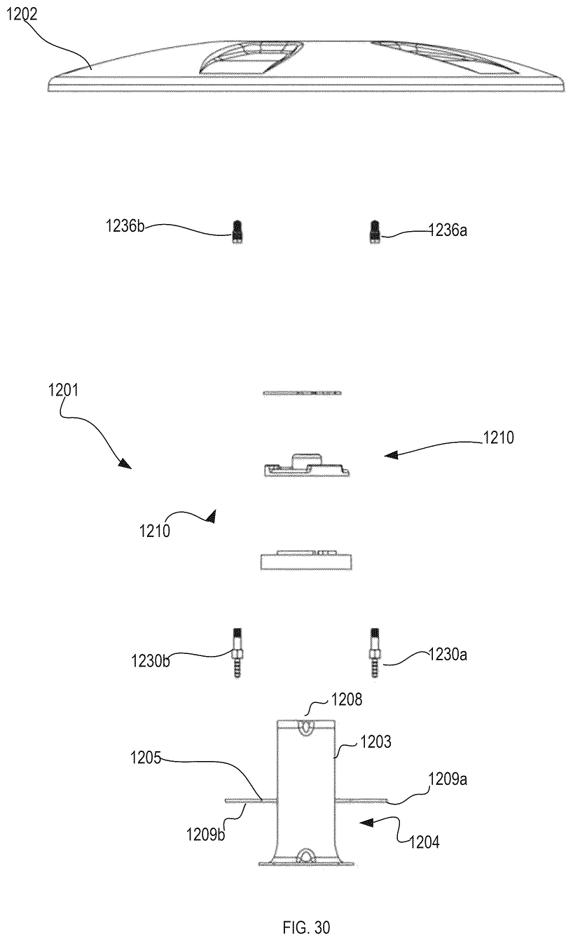

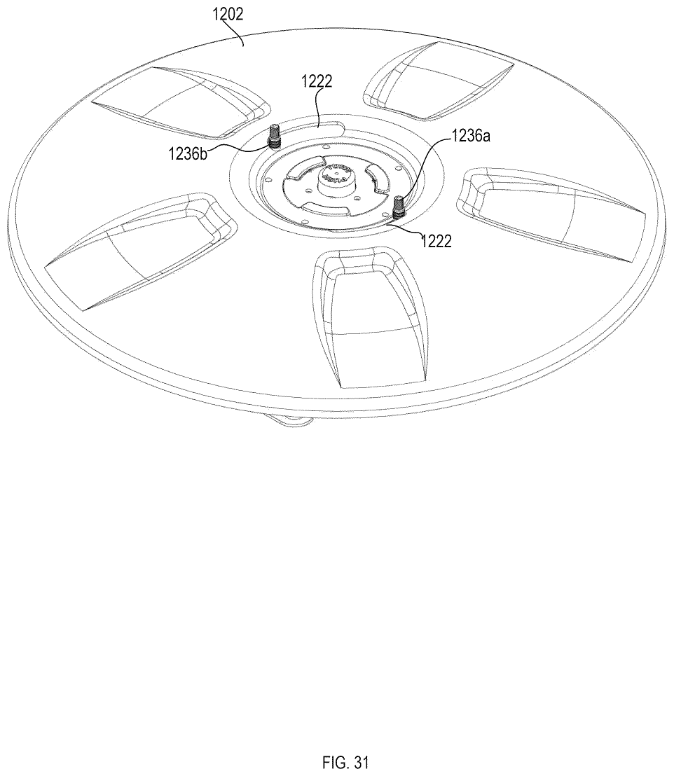

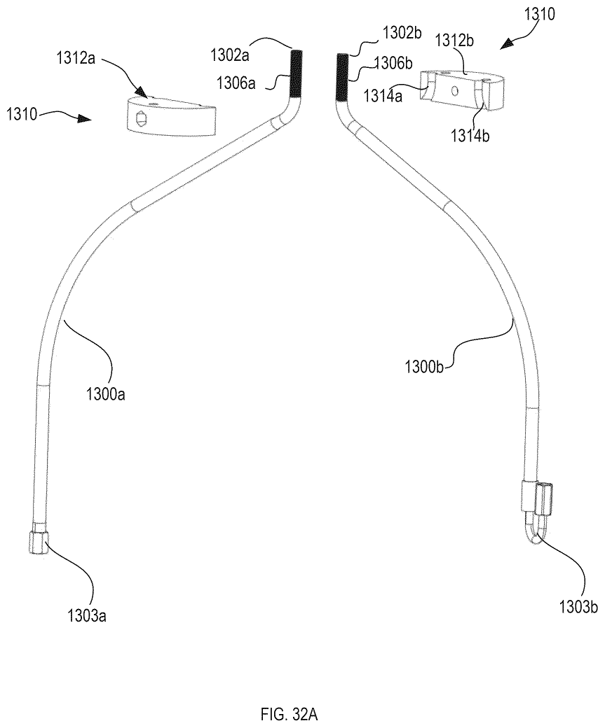

FIGS. 30 and 31 depict embodiments of aerodynamic wheel cover systems where the fittings are routed through the wheel cover 1202 of the assembly without being routed through the base assembly. Here, embodiments may include fittings for air lines connecting tractor tires to an accessible location through the wheel cover 1202 where the fittings mount to the wheel cover mounting bracket 1204 and fit through the wheel cover 1202 through openings 1222 which allow the cover to be taken on or off as needed.

In one embodiment, mounting assembly 1201 includes a mounting bracket 1204 and base assembly 1210. Mounting bracket 1204 includes a first bracket 1203 that mounts to the wheel hub and provides a mounting platform 1208 to which base assembly 1210 mounts. An offset mounting bracket 1205 is attached to the back of mounting platform 1208 by hardware, welding or other attachment mechanism. Offset bracket 1205 provides wings 1209a, 1209b, which include apertures that air fittings 1230a, 1230b traverse. Air fittings 1230a, 1230b may each house a valve core. The inboard ends of air fittings 1230a, 1230b may screw into or otherwise interface with an air line. Air fittings 1230a, 1230b may include internal valve cores, such as Schrader valves and valve opening features, such as valve opening pins, to hold open the internal valves of the air lines if used. Air fittings 1230a, 1230b may include external threads onto which a standard valve cap or second air fitting portions 1236a, 1236b, such as flow through valve caps, can be threaded. The openings 1222 to accommodate the accessible portions of the air fittings may be arcuate or otherwise curved or shaped to allow wheel cover 1202 to be turned during mounting/dismounting of wheel cover 1202.

The straight air fittings of FIGS. 30 and 31 are used simply as an example and other fittings according to the teachings herein may be arranged to pass through the wheel cover without passing through the base assembly. For example, air fittings 150a, 150b, 210a, 210b, 300a, 300b, 500a, 500b, 602a, 602b, 700a/730a, 700b/730b, the outboard ends of air lines with integrated fittings (e.g., air lines 800a, 800b, 1300a, 1300b), may be mounted to or routed through wings of a mounting bracket and through the wheel cover without passing through the base assembly.

Further, in some embodiments multiple air fittings are mounted to one side of the base assembly. For example, wing 1209a or wing 1209b may have multiple apertures to accommodate air fittings such that both the air fitting for the inner tire and the air fitting for the outer tire can be mounted to that wing. For example, multiple air fittings 150a, 150b, 210a, 210b, 300a, 300b, 500a, 500b, 602a, 602b 700a/730a, 700b/730b or outboard ends of air lines with integrated fittings (e.g., air lines 800a, 800b, 1300a, 1300b), may be routed to one side of the base assembly (e.g., using one of wings 1209a, 1209b). The other wing may be omitted or used for other purposes (e.g., such as mounting sensors, an onboard controller, LEDs, a display, an auditory device or other components of a wheel electronics system.

Moreover, wheel cover 1202 may include a central cap (e.g., central cap 103, 922, 1020, 1120). A wheel cover, such as wheel cover 1202, designed to accommodate air fittings that do pass not pass through the base assembly may include components such as, but not limited to: power components such as batteries or a solar cell to provide power to electronic components mounted to the wheel cover assembly or the wheel; components of a TPMS; an onboard controller; sensors; a receiver to receive data such as tire pressure, temperature, if one or more lug nuts are loose, treadwear, if a tire is out of balance or other data from sensors, an onboard computer, a camera that is positioned to monitor various components inboard or outside the wheel cover, such as components of the wheel assembly or wheel cover system, or other data sources; an input device to receive user input based on interaction with the input device; an output device or transmitter that displays or transmits data such as tire pressure, temperature, if one or more lug nuts are loose, treadwear, if a tire is out of balance, images or video from cameras, digital odometer readings, recommended maintenance schedule/items, advertising information, or other data; a visible indicator such as a blinking light that indicates if tire pressure, temperature, or other data is within normal operating range or out of normal operating range; an auditory signal device such as a speaker that produces a desired sound to alert an operator of an issue such as data from a sensor outside of normal operating range.

FIG. 32A illustrates another embodiment of a system for providing accessibility to tire air lines. FIG. 32B illustrates an inboard view of one embodiment of an aerodynamic wheel cover system incorporating the air delivery system of FIG. 32A. In the embodiment of FIG. 32A, air lines 1300a, 1300b include an inboard end fitting to connect to a respective tire valve stem (e.g., valve stem 16, 26). Air line 1300a includes inboard fitting 1303a to connect to the inboard outboard tire of a dual wheel arrangement and air line 1300b includes inboard fitting 1303b to connect to the outboard tire. The inboard ends air lines 1300a, 1300b may be configured with a feature to keep the valves of valve stems 16, 26 open when airlines 1300a, 1300b are connected to valve stems 16, 26. The outboard ends 1302a, 1302b of air lines 1300a, 1300b are sized and internally threaded to accommodate valve cores (e.g., such as valve cores 804a, 804b illustrated in FIG. 24A). In one embodiment, the valve cores are Schrader valve cores. Thus, the outboard ends 1302a, 1302b may be fitted with internal valves.

The outboard ends 1302a and 1302b may be equipped with integrated fittings. For example, these ends may feature external threads 1306a, 1306b designed to accommodate direct attachment of air tools, including but not limited to air hoses for inflating tires. Additionally, threaded fittings (e.g., threaded fittings 810a, 810b of FIG. 24A or other threaded fittings) may be secured onto threads 1306a and 1306b. These fittings may themselves possess external threads to facilitate further tool connections and may incorporate secondary valve mechanisms, such as flow-through valves. In a more particular embodiment, they are implemented as flow-through valve caps, including variants such as double-sealed flow-through valve caps.

In one embodiment, conventional valve caps may be threaded onto the external threads 1306a and 1306b to seal the exposed ends 1302a and 1302b of the air lines 1300a and 1300b. These caps can be removed by the operator to allow direct engagement of an air tool chuck-such as that of an inflation hose—with the outboard ends 1302a and 1302b.

Although not shown, air lines 1300a, 1300b may include secondary ports. The secondary port may, in some embodiments, include an internal valve, such as a Schrader valve or other valve. Alternatively, or in addition, the secondary port may include another air fitting. By way of example, but not limitation, the secondary port may be protected by and be accessible through a valve cap, such as a flow through valve cap designed for high pressure tractor-trailer tire service. In an even more particular embodiment, the valve caps are double sealed flow through valve caps. In another example embodiment, a conventional valve cap (one without a valve) is used to cover the secondary port when not in use.

A retainer 1310 is provided for positioning and mounting air lines 1300a, 1300b to a mounting bracket 1304, which may be similar to mounting bracket 101 in some embodiments. Retainer 1310 includes several portions (e.g., portion 1312a and portion 1312b) that assemble together, such as by being bolted together to clamp airlines 1300a, 1300b in respective engineered channels 1314a, 1314b. The portions 1312a, 1312b clamp together with sufficient force to retain air lines 1300a, 1300b without crushing them. Retainer 1310 may be made from plastic, metal, a composite material or other materials.

The inboard ends of the channels 1314a, 1314b are angled at the desired exit angle for the respective air line 1300a, 1300b. The outboard ends align with fitting apertures in mounting bracket 1304 (e.g., apertures 195 of mounting bracket 104) so that the outboard ends 1302a, 1302b can be routed through mounting bracket 1304 and the attached base assembly (e.g., base assembly 110) and wheel cover 1320, which may be an embodiment of wheel cover 102.

Retainer 1310 may include apertures to accommodate mounting hardware. For example, retainer 1310 may include apertures that align with hardware apertures in mounting bracket 1304, apertures 141 in base 114 (FIG. 11) and apertures 143 in alignment member 118 (FIG. 12) such bolts can pass through alignment member 118, base 114, mounting bracket 1304, and retainer 1310 and be secured with nuts 1307.

Embodiments of the invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Furthermore, any dimensions, materials or other such characteristics are provided by way of example and not limitation.

Tractor-trailers travel significant distances every year. Consequently, the cumulative effect of even incremental amounts of drag on a tractor-trailer can lead to significant increases in overall operating costs. Such increased transportation costs are typically absorbed by consumers of the products transported. One significant source of drag on tractor-trailers, and hence increased transportation costs, are the wheel assemblies of the tractor-trailers. In general, the aerodynamic drag of a vehicle increases when air flow is affected by a wheel opening, especially deep wheel openings commonly found on tractor-trailer vehicles. Consequently, there is a need for wheel covers that decrease drag. However, as discussed previously, previous solutions for attaching covers to hubs are unsatisfactory for use with tractor trailers. Accordingly, embodiments described herein provide mechanisms and methods for attaching cover assemblies to wheel assemblies (as used herein, the term “wheel assembly” may refer to a single wheel or a dual wheel assembly, particularly as it relates to a tractor-trailer vehicle).

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. An aerodynamic wheel cover system comprising:
a mounting bracket for mounting to a hub of a vehicle;
a base assembly mounted to the mounting bracket;
a wheel cover adapted to mount to the base assembly; and
a plurality of air fittings, each of the plurality of air fittings extending from an inboard side of the wheel cover through the wheel cover to a respective accessible location that is accessible when the wheel cover is mounted to the base assembly, wherein each of the plurality of air fittings includes an accessible portion accessible at the respective accessible location.

2. The aerodynamic wheel cover system of claim 1, wherein each of the plurality of air fittings connects a different vehicle tire to the respective accessible location.

3. The aerodynamic wheel cover system of claim 1, wherein each of the plurality of air fittings comprises a valve core.

4. The aerodynamic wheel cover system of claim 3, wherein each of the valve core in each of the plurality of air fittings comprises external valve core threads and wherein each of the plurality of air fittings comprises internal threads to interface with the external valve core threads.

5. The aerodynamic wheel cover system of claim 3, wherein the accessible portion of each of the plurality of air fittings comprises a flow through valve cap adapted to interface with a chuck of an air tool.

6. The aerodynamic wheel cover system of claim 1, wherein each of the plurality of air fittings comprises a first fitting portion to which the accessible portion couples, wherein the first fitting portion of each of the plurality of air fittings is mounted to the mounting bracket.

7. The aerodynamic wheel cover system of claim 6, wherein the first fitting portion of each of the plurality of air fittings is routed through the base assembly.

8. The aerodynamic wheel cover system of claim 6, wherein the first fitting portions of the plurality of air fittings are integrated into a single part.

9. The aerodynamic wheel cover system of claim 8, wherein the single part has a separate flow path for each of the plurality of air fittings.

10. The aerodynamic wheel cover system of claim 8, wherein the single part has a shared flow path for each of the plurality of air fittings.

11. The aerodynamic wheel cover system of claim 1, wherein each of the plurality of air fittings is routed through the mounting bracket and the base assembly.

12. The aerodynamic wheel cover system of claim 10, wherein the base assembly is a push-and-turn base assembly.

13. The aerodynamic wheel cover system of claim 12, wherein:
the base assembly comprises:
a base comprising extensions that extend outboard;
an alignment member fixed relative to the base, the alignment member comprising radially extending arms separated by first notches; and
a piston biased away from the base and toward the alignment member, the piston movable axially relative to the base and alignment member, the piston comprising:
a central shaft; and
an outer ring connected to the central shaft by spokes, the outer ring comprising ribs with second notches formed between the ribs, wherein the ribs align with the first notches and the radially extending arms align with the second notches, wherein the piston defines apertures between the spokes and wherein the extensions of the base extend into the apertures; and
the wheel cover comprises tabs that extend radially inward, the tabs adapted to be received through the first notches.

14. The aerodynamic wheel cover system of claim 1, wherein each of the plurality of air fittings comprises external threads and wherein the accessible portion of each of the plurality of air fittings comprises internal threads that interface with the external threads.

15. The aerodynamic wheel cover system of claim 1, further comprising:
a visible LED mounted to the wheel cover and visible when the wheel cover is mounted to the base assembly; and
an onboard controller adapted to provide control signals to the LED to provide environmental information about a wheel to a user.

16. The aerodynamic wheel cover system of claim 1, further comprising:
a display mounted to the wheel cover and visible when the wheel cover is mounted to the base assembly; and
an onboard controller adapted to provide control signals to the display to cause the display to display information about a wheel.

17. The aerodynamic wheel cover system of claim 1, wherein each of the plurality of air fittings includes a key and wherein the mounting bracket defines a respective keyhole slot to receive the key of each of the plurality of air fittings.

18. The aerodynamic wheel cover system of claim 17, wherein the plurality of air fittings bolt together.

19. The aerodynamic wheel over system of claim 17, further comprising a respective clip to retain each of the plurality of air fittings.

20. The aerodynamic wheel cover system of claim 1, wherein the plurality of air fittings do not pass through the base assembly.

21. The aerodynamic wheel cover system of claim 20, wherein the plurality of air fittings are mounted to at least one side of the base assembly.

22. The aerodynamic wheel cover system of claim 21, wherein the wheel cover defines arcuate slots to accommodate the accessible portion of each of the plurality of air fittings.

23. The aerodynamic wheel cover system of claim 1, further comprising:
a first air line having an inboard end and an outboard end, the outboard end of the first air line comprising a first air fitting from the plurality of air fittings; and
a second air line having an inboard end and an outboard end, the outboard end of the second air line comprising a second air fitting from the plurality of air fittings.

24. The aerodynamic wheel cover system of claim 23, wherein the first air fitting is integrated with the first air line and the second air fitting is integrated with the second air line.

25. An aerodynamic wheel cover system comprising:
a wheel cover attached to a mounting bracket;
a center cap attached to the wheel cover;
one or more sensors configured to provide signals containing information about a wheel; and
a display attached to the center cap configured to display information about a wheel.
